(19) United States
(12) Patent Application Publication
(10) Pub. No.: US 2026/0364646 A1
(43) Pub. Date: Nov. 19, 2026

(54) DISPENSING SYSTEMS AND METHODS OF USE

(71) Applicant: Quick Quack Car Wash Holdings, LLC, Roseville, CA (US)

(72) Inventors: Christopher Clinton Chappell, Lincoln (CA); Rodney Daniel Sparks, Roseville, CA (US); McNamara Marlow Pope, III, Fair Oaks, CA (US); Roshyla Malondra Ruiz, Sacramento, CA (US); Daniel Humberto Gonzalez, Citrus Heights, CA (US); Spencer Robert Drennan, Folsom, CA (US); Yesenia Silva, Rio Linda, CA (US); Brent Edmund Duff, Lincoln, CA (US)

(73) Assignee: Quick Quack Car Wash Holdings, LLC, Roseville, CA (US)

(21) Appl. No.: 19/657,154

(22) Filed: Apr. 24, 2026

Related U.S. Application Data
(60) Provisional application No. 63/794,590, filed on Apr. 25, 2025.

(51) Int. Cl. B08B 3/08; B08B 3/02; B60S 3/04

(52) U.S. Cl. CPC B08B 3/08; B08B 3/02; B60S 3/04

(57) ABSTRACT

A dispensing system for a vehicle wash, comprising a modular skid frame, a storage tank supported by the modular skid frame and configured to hold an active agent, a pump fluidly connected to the storage tank, a fluid line configured to provide a pressurized fluid greater than an atmospheric pressure level to the dispensing system, a solenoid valve fluidly connected to the fluid line and a dilution block fluidly connected to both the solenoid valve and the pump, the dilution block configured to receive the pressurized fluid from the solenoid valve and the active agent from the pump to create a mixture.

### CROSS-REFERENCE TO RELATED APPLICATIONS

This application claims the benefit of priority of U.S. Provisional Patent Application Serial No. 63/794,590, filed on Apr. 25, 2025, and titled “SYSTEMS AND METHODS FOR DISPENSING SYSTEMS,” which is incorporated by reference herein in its entirety.

### FIELD OF THE INVENTION

The present invention generally relates to the field of dispensing systems. In particular, the present invention is directed to modular dispensing systems and methods of use.

### BACKGROUND

Proper ratios of liquids to active agents are crucial for both efficiency and effectiveness in cleaning processes. Using too little of an active agent can lead to inadequate cleaning, leaving behind bacteria or residues, while using too much can waste product, create buildup, or require excessive rinsing thereby wasting time and water. Precise fluid ratios allow for active agents to be properly utilized without damaging the product that is being cleaned. Current systems lack the capability to allow for both modularity and for precise measurement ratios of liquids.

### SUMMARY OF THE DISCLOSURE

In an aspect, a dispensing system for a car wash is described. The dispensing system includes a modular skid frame, a storage tank supported by the modular skid frame and configured to hold an active agent, a pump fluidly connected to the storage tank, a fluid line configured to provide a pressurized fluid greater than an atmospheric pressure level to the dispensing system, a solenoid valve fluidly connected to the fluid line and a dilution block fluidly connected to both the solenoid valve and the pump, the dilution block including a venturi injector configured to receive the pressurized fluid from the solenoid valve and the active agent from the pump to create a mixture.

In another aspect, another dispensing system for a car wash is described. The dispensing system includes a modular skid frame, a plurality of storage tanks supported by the modular skid frame, wherein each storage tank of the plurality of storage tanks is configured to hold an active agent, a plurality of pumps fluidly connected to the plurality of storage tanks, a fluid line configured to provide pressurized fluid greater than an atmospheric pressure level to the dispensing system, a plurality of solenoid valves fluidly connected to the fluid line and configured to provide a separate fluid stream for each dilution block of a plurality of dilution blocks and the plurality of dilution blocks fluidly connected to the plurality of solenoid valves and the plurality of pumps, wherein each dilution block includes a venturi injector configured to receive the pressurized fluid from at least one solenoid valve of the plurality of solenoid valves and the active agent from at least one pump of the plurality of pumps to create a mixture.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of a dispensing system;

FIG. 2 is another exemplary embodiment of the dispensing system;

FIGS. 3A-B illustrate exemplary side views of the dispensing system;

FIG. 4 illustrates yet another exemplary embodiment of the dispensing system;

FIG. 5 illustrates an exemplary embodiment of a dispensing station;

FIG. 6 illustrates yet another exemplary embodiment of the dispensing station;

FIG. 7 illustrates yet another exemplary embodiment of the dispensing system;

FIG. 8 illustrates an exemplary embodiment of a dilution block;

FIG. 9 illustrates an exemplary embodiment of an injector system;

FIG. 10 illustrates an exemplary embodiment of a peristaltic pump;

FIG. 11 illustrates yet another exemplary embodiment of the dispensing system;

FIGS. 12A-B illustrates yet additional exemplary embodiments of the dispensing system;

FIG. 13 illustrates an exemplary embodiment of a rear manifold of the dispensing system;

FIG. 14 illustrates another exemplary embodiment of the rear manifold of the dispensing system;

FIGS. 15A-B illustrate an exemplary embodiment of an injector system;

FIG. 16 is an exploded view of the injector system;

FIG. 17 is a block diagram of an exemplary system for creating mixtures;

FIG. 18 is an exemplary embodiment of an airbox;

FIGS. 19A-19B are exemplary embodiments of the airbox;

FIG. 20 is a flow diagram of an exemplary method for dispensing a soap mixture in a vehicle wash system; and

FIG. 21 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for a distribution system. In an embodiment, the distribution system is configured to intake water and soap, monitor soap levels and conditions in real time, and delivers a consistent, controlled soap dilution to every vehicle. In an embodiment, the system utilizes a modular architecture including self-contained skids to manage the fluidic and electrical components necessary for car wash operations.

Aspects of the present disclosure can be used to achieve precisely metered chemical applications across various stages of a wash sequence. Aspects of the present disclosure can also be used to facilitate rapid deployment and maintenance of dispensing hardware in a car wash facility. This is so, at least in part, because the modular skid frame is designed to be "pallet jackable" and "forkliftable," and the system utilizes standardized utility connections and a "Soap Spy" hardware interface to integrate with external wash controllers via MQTT. In one or more embodiments, soap spy may include an electronic device meant to interface discrete output signals from a legacy wash controller with a networked soap control system as an alternative to connecting discrete wires between the wash controller and the soap controller for each soap.

Aspects of the present disclosure allow for the automated monitoring and adjustment of chemical concentrations through the use of tank level sensors, water quality sensors (e.g., pH and TDS), and adaptive pump trim algorithms that ensure the delivery of a consistent soap dilution despite variations in chemical viscosity or incoming water quality. Exemplary embodiments illustrating aspects of the present disclosure are described below in the context of several specific examples.

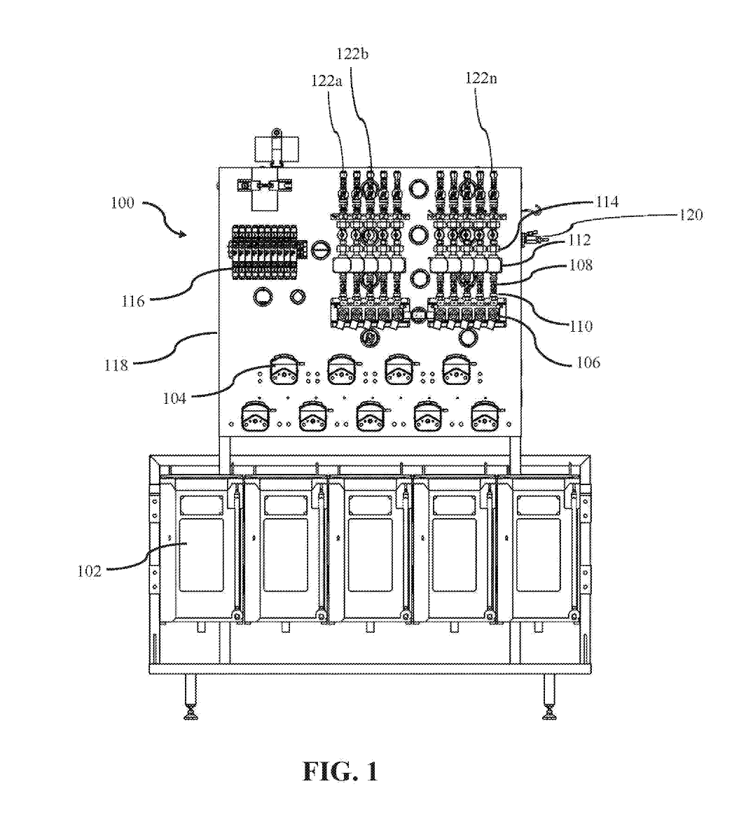

Referring now to FIG. 1, an exemplary embodiment of a dispensing system 100 is described. In one or more embodiments, dispensing system may be configured to dispense a fluid. In one or more embodiments, dispensing system may be configured to control dilution rates of an active agent such as soap. In one or more embodiments, dispensing system may control dilution rates by means of controlling active agent flow rates and dilutant flow rates. In one or more embodiments, dispensing system may further be configured to create a foam by controlling air intake into a mixture of soap and water and/or an active agent and fluid. In one or more embodiments, dispensing system may further be configured to create foam through air injection, wherein air may be pushed into the liquid stream. In one or more embodiments, dispensing system 100 may be configured to dispense a mixture containing fluid and an active agent. An “active agent” as described in this disclosure refers to chemical and/or combination of chemicals that is ultimately used to clean a device or product. For example, and without limitations, active agent may include chemicals used to clean, or apply the aforementioned solid or liquid film to, a car tire, and/or the like. In one or more embodiments, active agent may include water-soluble substances used to create a solid or liquid film on the surface of the device or product being cleaned for the purpose of enhancing hydrophobicity, shine, repulsion of particulates, or effectiveness of rinsing of other active agents. In one or more embodiments, an active agent may include a soap, a cleaning agent and/or any other combinations of fluids and/or solvents. In one or more embodiments, dispensing system may be configured to mix and active agent, such as soap and a fluid, such as water to create a mixture.

With continued reference to FIG. 1, dispensing system 100 includes a modular skid frame 118. A “modular skid frame” as described in this disclosure is a structural chassis designed to house the mechanical, fluidic, and/or electrical components of a system as a single unit. In one or more embodiments, modular skid frame 118 may be configured to support and organize the mechanical, fluidic, and electrical components of the system as a cohesive, mobile assembly. The modular skid frame 118 may be constructed from structural members, such as stainless steel or aluminum square tubing, providing a rigid chassis for the mounting of a plurality of storage tanks 102, peristaltic pumps 104, and manifold assemblies. In one or more embodiments, the modular skid frame 118 may be engineered for mobility and rapid installation, featuring integrated forklift pockets and a base height configured to receive the tines of a standard pallet jack. In one or more embodiments, modular skid frame 118 may include a self-contained unit configured for transport. For the purposes of this disclosure, a “self-contained unit” is a discrete, pre-assembled module that incorporates all primary internal hardware and control logic necessary for operation, such that it can function independently or in tandem with another unit upon connection to a limited set of external utilities. As a self-contained unit, the modular skid frame 118 may house its own dedicated controller, dilution blocks, and internal wiring harnesses, eliminating the need for complex field-wiring of individual sensors or pumps. To become fully operational, the modular skid frame 118 may require only four primary external connections: a power connection (e.g., 277V AC) to provide energy to the controller and pump motors; a data connection (e.g., Ethernet or PoE) for network communication and emergency stop signaling; a pressurized water inlet fluidly connected to the central fluid line 120 to supply the dilution channels; and a compressed air inlet to supply the air manifold and associated foam applicators. In one or more embodiments, the modular skid frame 118 may be configured to facilitate maintenance within its own footprint through integrated structural features. The frame may include a rear-access portion moveably coupled to the main chassis, such as a flip-up door supported by one or more gas struts, which allows internal components to be serviced while the unit remains in its installed position. Additionally, the frame may include an integrated horizontal support bar with a pre-drilled lifting point positioned vertically above high-mass components, such as a water booster pump or motor, allowing for the installation of an eye-bolt to assist in the removal or replacement of said components. By consolidating these features into a self-contained unit, the modular skid frame 118 enables a plug-and-play” deployment model that reduces the time and technical expertise required for on-site setup. In one or more embodiments, the modular skid frame 118 may be transportable such that it is not fixed to a surface and can be removably attached and moveable when needed. In one or more embodiments, the modular skid may be moved with a pallet jack and connected to external water supplies and electrical supplies.

With continued reference to FIG. 1, in one or more embodiments, dispensing system may include one or more storage tanks 102 supported by the modular skid frame 118. In one or more embodiments, storage tanks may be screwed, adhered, and otherwise connected to modular skid frame 118. In one or more embodiments, modular skid frame may include and/or be consistent with any skid as described in this disclosure, such as but not limited to, first skid and/or second skid. In one or more embodiments, an active agent may be applied to a car wash system and/or to a device, such as vehicle without dilution with fluid. In one or more embodiments, dispensing system may be configured to control flow rate of active agent into system. In one or more embodiments, storage tanks 102 may be configured to store one or more active agents. In one or more embodiments, each storage tank 102 of a plurality of storage tanks may be configured to house and/or store a separate active agent, such as for example, a soap for a differing purpose. In one or more embodiments, storage tanks 102 may include sensors, such as but not limited to, proximity sensors, ultrasonic sensors, pressure sensors, and/or the like to sense an amount of active agent within each storage tank 102. In one or more embodiments, storage tanks 102 may include any storage tanks as described in this disclosure. In one or more embodiments, storage tanks may include level sensors, ultrasonic sensos, radar sensors, pressure differential sensor, and/or the like,

With continued reference to FIG. 1, dispensing system 100 may include one or more peristaltic pumps 104. A peristaltic pump, also known as a hose or tube pump, is a type of positive displacement pump that moves fluids through a flexible tube using a rotating mechanism. The core working principle involves compressing and releasing the tube in a sequential manner to create a vacuum effect that draws fluid into the tubing and pushes it forward. This may be achieved by rollers or shoes mounted on a rotating rotor that press against the tubing, pinching it closed at multiple points. As the rotor turns, the pinched section moves along the tube, pushing the liquid ahead while drawing more liquid in behind it. Since the fluid only contacts the inner surface of the tubing, this pump design is especially suited for sterile, corrosive, or abrasive fluids, making it popular in medical, pharmaceutical, food processing, and chemical industries. It is also highly valued for its ability to handle shear-sensitive materials gently, its self-priming capability, and its ability to run dry without damage. Maintenance is straightforward, typically involving only tube replacement since the tubing is the primary wear component. Additionally, flow rate can be easily adjusted by changing the rotor speed or tube diameter, giving the peristaltic pump flexibility across a wide range of applications. In one or more embodiments, a different style of positive displacement pump might be used in lieu of peristaltic pump, such as but not limited to, a vane pump, a gear pump, a gerotor pump, Roots-type pump, a rotary motor or solenoid-driven diaphragm pump, a piston pump, or a progressive cavity pump. A non-positive displacement pump could also be used if its flow rate is monitored by a flow measurement system such as an orifice and differential pressure sensor, an ultrasonic flow sensor, a thermal mass flow sensor, a positive displacement flow sensor (e.g., microgear), a turbine flow sensor, or an electromagnetic flow sensor. In one or more embodiments, any positive displacement pump may be used to pump active agent through system. In one or more embodiments, peristaltic pump may be used to measure a flow rate of active agent within dispensing system 100.

With continued reference to FIG. 1, each storage tank 102 may include and/or be fluidly connected to a peristaltic pump 104 configured to move and/or pump active agent or soap from storage tanks. In one or more embodiments, peristaltic pump may be used to monitor precise flow of an active agent such as soap. In one or more embodiments, peristaltic pump may be activated and/or controlled using pressure and/or flow sensors. In one or more embodiments, each storage tank 102 may be fluidly connected to a peristaltic pump, such that active agents, such as soap within storage tank are pumped and/or extracted using peristaltic pumps 104. Peristaltic pumps are described in further detail below. In one or more embodiments, peristaltic pump may include gear pumps configured to high pressure and high precision flow. In one or more embodiments, each storage tank may contain level sensors configured to sense an active agent within each storage tank 102. In one or more embodiments, level sensors may identify the presence of active agent and thus the amount of active agent remaining within each storage tank 102. In one or more embodiments, level sensors may be used to determine when a storage tank 102 has been depleted of active agent and thus requires additional active agent. In one or more embodiments, level sensors may further be used to identify degradation within the piping of dispensing system 100. In one or more embodiments, a controller, such as any controller as described in this disclosure may identify a flow rate of active agent exiting storage tank 102 and thus identify a flow rate of active agent entering dilution block. In one or more embodiments, flow rates identified by level sensor and flow rate identified by other sensors may be used to determine component degradation, pipe degradation, and/or the like. In one or more embodiments, the level sensors may include an ultrasonic sensing assembly mounted to a top portion of the storage tank 102. To ensure measurement accuracy in the presence of surface turbulence or chemical aeration, the storage tank 102 may further include a cylindrical tube extending vertically from the top of the storage tank 102 toward the bottom. The cylindrical tube may be configured to provide an isolated column of the active agent that is substantially free from foam or bubbles that may accumulate on the broader surface of the liquid within the storage tank 102. In one or more embodiments, the cylindrical tube may include a rigid conduit, such as a 2-inch diameter stainless steel pipe, which serves as a dedicated channel for the ultrasonic sensor’s signal. By directing the ultrasonic signal through the interior of the cylindrical tube, the sensor can measure the true liquid level of the active agent by reflecting off the clean liquid surface within the tube, effectively bypassing surface foam which would otherwise scatter the ultrasonic waves and lead to erroneous readings. In one or more embodiments, the high-precision data provided by the ultrasonic sensor via the cylindrical tube may be communicated to a controller to facilitate advanced diagnostic logic. The controller may be configured to correlate the volumetric decrease in the storage tank 102 with the commanded rotations of the peristaltic pump 104. By comparing the actual liquid displacement measured through the cylindrical tube against the predicted flow rate of the pump, the controller can calculate a “pump trim” value. This trim value may be used to automatically adjust pump speed to compensate for mechanical factors such as tubing fatigue or changes in agent viscosity, thereby maintaining the precise chemical ratios required for the dispensing system 100. In one or more embodiments, cylindrical tube may include an ultrasonic sensor mounted to cylindrical tube to measure the levels of mixture. In one or more embodiments, cylindrical tube may include a waveguide tube.

With continued reference to FIG. 1, dispensing system 100 may include one or more water solenoids 106. A “water solenoid” as described in this disclosure is a component used to distribute water (or water-based mixtures) from a single input source to multiple output lines or dispensing points. In one or more embodiments, water solenoid may include any solenoid actuator as described in this disclosure. In one or more embodiments, water solenoid may include and/or be consistent with a solenoid valve. The water solenoid may serve as a centralized control and distribution block, allowing water or mixtures to be directed accurately and efficiently to different destinations, such as dispensing nozzles, mixing tanks, or processing equipment. In one or more embodiments, water solenoids 106 may be made from stainless steel, plastic, or other corrosion-resistant materials. In one or more embodiments, water solenoids 106 may include valves, flow meters, pressure gauges, sensors for real-time monitoring and precise control over a flowrate and composition. In one or more embodiments, water solenoids 106 may include valves that allow for a fluid, such as water to enter dispensing system 100. In one or more embodiments, water solenoids may include electrical, pneumatic and/or any other sort of valves that control the flow of a fluid. In one or more embodiments, water solenoids may include actuators that control the flow of a fluid, such as water.

With continued reference to FIG. 1, water solenoid may include one or more valves used to control the flow of a fluid such as water. For the purposes of this disclosure, a “valve” is a component that controls fluidic communication between two or more components. As nonlimiting examples, valve may include directional valves, control valves, selector valves, multi-port valves, check valves, and the like. Valves may include any suitable valve construction including ball valves, butterfly valves, needle valves, globe valves, gate valves, wafer valves, regulator valves, and the like. Valves may be included in a manifold of hydraulic or pneumatic circuit, for example allowing for multiple ports and flow paths. Valves may be actuated by any known method, such as without limitation by way of hydraulic, pneumatic, mechanical, or electrical energy. For instance, in some cases, valve may be actuated by an energized solenoid or electric motor, as described above. Valve actuators and thereby valves themselves may be controlled by computing device. Computing device and/or control unit may be in communication with valve, for example by way of one or more of electrical communication, hydraulic communication, pneumatic communication, mechanical communication, and the like. A person of ordinary skill in the art, upon reviewing the entirety of this disclosure, will be able to recognize how devices such as flow rate sensors and valves may be implemented within dispensing system 100.

For the purposes of this disclosure, an “actuator” is a device or a component of a machine that produces force, torque, or displacement, usually in a controlled manner, when an electrical, pneumatic, or hydraulic input is supplied to it in an actuating system and converted into a required form of mechanical energy. Actuator may, in some cases, require a control signal and/or a source of energy or power, as described below in this disclosure. In some cases, control signal may be relatively low energy. Exemplary control signal forms include electric potential or current, pneumatic pressure or flow, hydraulic fluid pressure or flow, mechanical force/torque or velocity, or even human power. In some cases, actuator may have source of energy or power other than control signal. This may include a main energy source, which may include for example electric power, hydraulic power, pneumatic power, mechanical power, and/or the like. In some cases, upon receiving control signal, actuator may respond by converting source power into mechanical motion. In some cases, actuator may be understood as a form of automation or automatic control.

With continued reference to FIG. 1, in one or more embodiments, actuator may include a hydraulic actuator. Hydraulic actuator may consist of a cylinder or fluid motor that uses hydraulic power to facilitate mechanical operation. Output of hydraulic actuator may include mechanical motion, such as without limitation linear, rotatory, or oscillatory motion. In some cases, hydraulic actuator may employ a liquid hydraulic fluid. As liquids, in some cases, are incompressible, hydraulic actuators may be capable of exerting large forces. Additionally, as force is equal to pressure multiplied by area, hydraulic actuators may act as force transformers with changes in area (e.g., cross-sectional area of a cylinder and/or piston). An exemplary hydraulic cylinder may consist of a hollow cylindrical tube within which piston can slide. In some cases, hydraulic cylinder may be considered single acting. A single-acting piston may be used when fluid pressure is applied substantially to just one side of the piston. Consequently, single-acting piston may move in only one direction. In some cases, a spring may be used to give single-acting piston a return stroke. In some cases, hydraulic cylinder may be double acting. A double-acting piston may be used when pressure is applied substantially on each side of the piston; any difference in resultant force between the two sides of piston may cause the piston to move.

With continued reference to FIG. 1, in one or more embodiments, actuator may include a pneumatic actuator. In some cases, pneumatic actuators may enable considerable forces to be produced from relatively small changes in gas pressure. In some cases, pneumatic actuators may respond more quickly than other types of actuators, for example hydraulic actuators. Pneumatic actuators may use compressible fluid. In some cases, pneumatic actuators may operate on compressed air. Operation of hydraulic and/or pneumatic actuators may include control of one or more valves, circuits, fluid pumps, and/or fluid manifolds.

With continued reference to FIG. 1, in some cases, actuator may include an electric actuator. Electric actuator may include any electromechanical actuators, linear motors, and the like. Electromechanical actuators may convert a rotational force of an electric rotary motor into a linear movement to generate a linear motion through a mechanism. Exemplary mechanisms include rotational-to-translational motion transformers, such as without limitation a belt, a screw, a crank, a cam, a linkage, a scotch yoke, and the like. In some cases, control of electromechanical actuator may include control of electric motor; for instance, control signal may control one or more electric motor parameters to control the electromechanical actuator. Nonlimiting examples of electric motor parameters include rotational position, input torque, velocity, current, and potential. Electric actuator may include a linear motor. Linear motors may differ from electromechanical actuators, as power from linear motors is output directly as translational motion, rather than output as rotational motion and converted to translational motion. In some cases, linear motor may cause less friction loss than other devices. Linear motors may be further specified into at least three different categories, including flat linear motor, U-channel linear motors, and tubular linear motors. Linear motors may be directly controlled by control signal for controlling one or more linear motor parameters. Nonlimiting examples of linear motor parameters include position, force, velocity, potential, and current. In some cases, electric actuator may include a solenoid actuator. For the purposes of this disclosure, a “solenoid” is a device capable of converting electrical energy into mechanical work; it includes a coil of wire, a housing, and a movable plunger; when an electrical current is introduced, a magnetic field forms around the coil which moves the plunger.

With continued reference to FIG. 1, in one or more embodiments, actuator may include a mechanical actuator. In some cases, mechanical actuator may function to execute movement by converting one kind of motion, such as rotary motion, into another kind, such as linear motion. An exemplary mechanical actuator includes without limitation a rack and pinion. In some cases, a mechanical power source, such as a power take-off, may serve as a power source for mechanical actuator. Mechanical actuators may employ any number of mechanisms, including for example gears, rails, pulleys, cables, linkages, and the like.

With cotninued reference to FIG. 1, dispensing system 100 may include a plurality of water solenoids 106, wherein each water solenoid may be configured for a separate storage tank 102 containing a separate active agent. In one or more embodiments, each storage tank 102 may be assigned a separate water solenoid which is used to mix active agent with fluid within water solenoid. In one or more embodiments, each storage tank 102 may be assigned more than one water solenoids for redundancy.

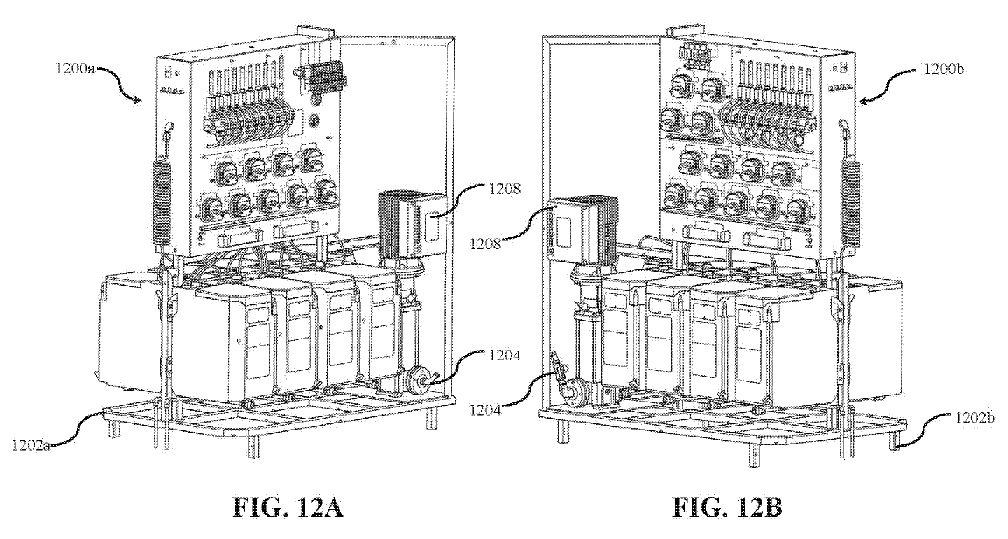

With continued reference to FIG. 1, each water solenoid 106 may be connected to a central fluid line, such as a central fluid line 120 that provides fluids to dispensing system 100. In one or more embodiments, the dispensing system 100 includes central fluid line 120 configured to serve as the primary fluid inlet for providing pressurized fluid to the entire dispensing system 100. In one or more embodiments, the central fluid line 120 may include a primary line, hose or tubing that provides water to dispensing system. In one or more embodiments, the central fluid line 120 may serve as the primary intake of fluid or water into dispensing system. The central fluid line 120 may be fluidly connected to a municipal or facility water source and acts as a common supply header that distributes water to both a first skid and a second skid. To ensure the consistent performance of the downstream dilution blocks, the central fluid line 120 may be configured to maintain a stabilized operating pressure, which is essential for the generation of a full vacuum within venturi injectors. In one or more embodiments, the central fluid line 120 may include a pressure boosting assembly (as illustrated in FIGS. 12A-B) containing a plurality of redundant water booster pumps. The booster pumps may be configured to increase the incoming city water pressure to a target operating pressure of approximately 150 PSI. The plurality of booster pumps may be wired to communicate via a serial protocol, such as RS485, allowing them to operate in a “Cascade mode.” In this mode, the pumps negotiate their operation such that a secondary pump automatically activates to maintain system pressure if the primary pump fails or if the volumetric demand exceeds the capacity of a single pump. In one or more embodiments, the central fluid line 120 may be fluidly connected to a plurality of water solenoids 106 arranged in a manifold configuration. Each water solenoid 106 serves as a selective gate that, when actuated by the controller, allows a pressurized fluid to flow from the central fluid line 120 into a designated channel 108. In one or more embodiments, a pressurized fluid includes a fluid containing a fluid having a pressure level higher than an atmospheric pressure level. By utilizing a common central line, the system ensures that every dilution channel receives fluid at a uniform pressure, which is critical for maintaining precise soap-to-water ratios across the multiple application stages of the car wash sequence. In one or more embodiments, the central fluid line 120 may further include an integrated water quality monitoring assembly positioned upstream of the water solenoids 106. This assembly characterizes the pressurized fluid before it is distributed to the individual channels and may include sensors for measuring pH, Total Dissolved Solids (TDS), and conductivity. The data from these sensors may be transmitted to the controller, enabling the system to treat the incoming water as a known variable and allowing for real-time adjustments to the dispensing logic to compensate for fluctuations in water hardness or chemical composition.

With continued reference to FIG. 1, in one or more embodiments, each water solenoid may provide fluid to a designated channel 108. In one or more embodiments, designated channel 108 may include piping and/or a means to transfer fluid from water solenoid through dispensing system 100. In one or embodiments, designated channel may include tubular piping made of aluminum, steel, plastic and/or the like and be configured to route fluid from water manifold through dispensing system. In one or more embodiments, each water solenoid may be fluidly connected to designated channel. In one or more embodiments, each designated channel 108 may include a sensor, such as a pressure sensor and/or flow meter configured to identify a pressure or flow of from each water solenoid. in one or more embodiments, dispensing system 100 may further include a flow rate sensor. For the purposes of this disclosure, a “flow rate sensor” is a device installed adjacent to a stream of liquid and configured to measure its real-time flow rate, i.e., the amount or volume of fluid that passes through per unit time, in gallons per minute, liters per minute, milliliters per minute, gallons per second, liters per second, milliliters per second, or another unit similar thereto. As a nonlimiting example, when liquid flow is steady, i.e., with a constant or nearly constant flow rate, duration of liquid flow may be calculated by dividing the amount/volume of liquid by the flow rate. In one or more embodiments, dispensing system 100 may include a pressure sensor 110 at or near water solenoid 106 in order to identify a pressure of fluid from water solenoid and in designated channel. In one or more embodiments, pressure sensor 110 may be used to ensure pressure isn’t starved.

With continued reference to FIG. 1, dispensing system 100 may be fluidly connected to a central fluid line wherein the central fluid line may include a water quality monitoring assembly positioned upstream of the water solenoids 106 to analyze the chemical characteristics of the fluid before it enters the dispensing system 100. The water quality monitoring assembly may include a plurality of analytical sensors, such as a pH sensor, a Total Dissolved Solids (TDS) sensor, and a conductivity sensor. These sensors are fluidly connected to the input lines of the skid and are in electrical communication with the controller to provide continuous, real-time data regarding the composition and quality of the incoming water supply. In one or more embodiments, a controller may be configured to utilize the data from the water quality monitoring assembly to execute an adaptive dilution logic. Because variations in water hardness (measured via TDS and conductivity) and acidity (measured via pH) can significantly alter the chemical efficacy of soaps and active agents, the controller may dynamically adjust the dispensing parameters to maintain a consistent mixture. For example, upon detecting an increase in TDS levels indicating hard water, the controller may automatically increase the output of the peristaltic pump 104 or adjust the actuation of the water solenoid 106 to increase the soap-to-water ratio. This closed-loop feedback ensures that the cleaning properties of the mixture remain uniform regardless of fluctuations in the municipal water source. In one or more embodiments, the water quality monitoring assembly is integrated into the sensor network to facilitate predictive maintenance and site-wide diagnostics. A controller may be configured to log water quality trends and generate specific fault codes if the pH or TDS levels exceed predefined thresholds. By monitoring these characteristics at the input line, the system can identify potential failures in on-site water treatment or softening equipment before the water reaches the designated channels 108, thereby protecting the internal components of the dispensing system 100 from mineral scaling or chemical degradation.

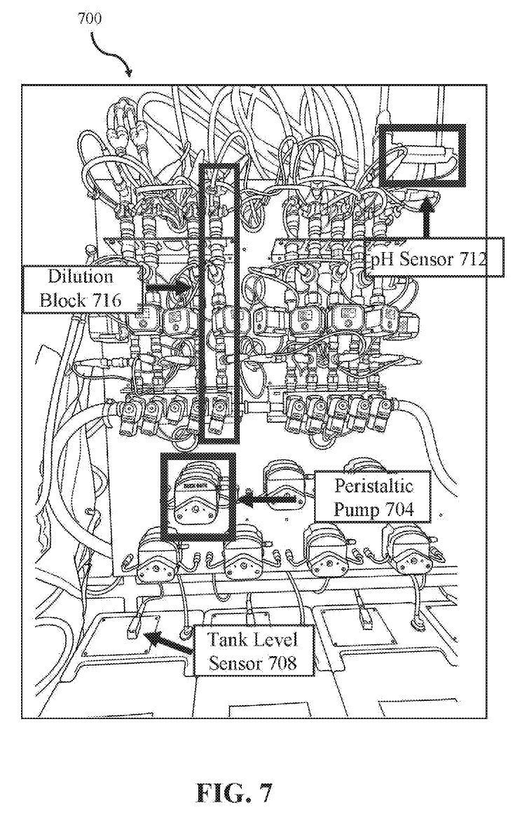

With continued reference to FIG. 1, in one or more embodiments, dispensing system 100 includes a plurality of dilution blocks 122a-n, wherein each dilution block 122a-n serves as the primary mixing interface for combining pressurized fluid with an active agent. For the purposes of this disclosure, a “dilution block” is an integrated mechanical assembly configured to receive separate fluid and chemical inputs and utilize hydrodynamic principles to generate a metered mixture. In one or more embodiments, the dilution block 122a-n is a custom-machined stainless-steel unit that consolidates multiple fluidic components into a single housing to minimize potential leak points and facilitate consistent flow characteristics across the dispensing station. In one or more embodiments, the dilution block 122a-n includes a Venturi injector, such as a DEMA injector, which is the core component for generating the mixture. The Venturi injector includes a nozzle having a sized orifice, often measured to within a thousandth of an inch, which dictates the water flow rate and the suction strength of the specific channel. To prevent the backflow of the mixture into the chemical delivery lines, the dilution block 122a-n further includes an integrated check valve assembly situated at a soap injection barb. This check valve assembly may include a ball, a spring, and one or more O-rings configured to permit the one-way positive displacement of the active agent into the water stream. In one or more embodiments, the dilution block 122a-n may incorporate one or more pressure sensors 110 and barbed fittings for connecting to the peristaltic pump 104 and secondary diagnostic lines. In one or more embodiments, the dilution block 122a-n interacts with the overall system by functioning as the convergence point for the water and chemical circuits. The dilution block 122a-n is fluidly connected to a corresponding water solenoid 106, which provides a stream of boosted water (e.g., approximately 150 PSI) from the central fluid line. In one or more embodiments, the dilution block 122a-n is fluidly connected to a peristaltic pump 104, which delivers the active agent from a storage tank 102. As the boosted water is forced through the nozzle orifice within the dilution block 122a-n, its velocity increases, creating a localized vacuum that “sucks” the concentrated active agent from the pump line into the high-velocity water stream. This hydraulic interaction allows the system to achieve consistent, controlled soap dilutions that are resistant to fluctuations in chemical viscosity, with the final mixture being outputted to the designated wash applicators. Dilution block 122a-n is described in further detail below such as in reference to at least FIGS. 7, 8 and 9.

With continued reference to FIG. 1, In one or more embodiments, dispensing system 100 and/or dilution block may incorporate a high-pressure positive-displacement pump, such as a gear pump, to facilitate the direct injection of the active agent into the water stream. This configuration may be designed to overcome system backpressure by delivering chemicals at a regulated high pressure of approximately 75 PSI thereby eliminating the necessity for a Venturi injector to generate suction. While a standard peristaltic pump may be effective for metering, it may lack the requisite pressure to push chemicals directly into a pressurized line. As a result, the use of a gear pump may allows for a simplified fluid circuit that converged at a standard T-junction. In one or more embodiments, water flow may be governed by either a flow-limiting orifice or a proportional valve, while the chemical flow rate may be metered by the pump’s RPM. To maintain system integrity and prevent backflow when water pressure exceeds chemical line pressure, a check valve may be installed on the chemical line at the point of convergence.

With continued reference to FIG. 1, in one or more embodiments, dispensing system 100 includes a venturi injector. The venturi injector is a hydrodynamic device situated within the dilution block 122a-n and configured to operate as a high-precision chemical metering unit. The venturi injector may include a DEMA-type injector characterized by an internal fluid path that narrows into a precisely sized orifice. This orifice is the primary governing component for the specific wash channel, as its internal diameter, which can be precisely measured to within a thousandth of an inch, dictates both the volume of water permitted to pass through and the magnitude of the suction force generated for that particular application. In one or more embodiments, the venturi injector is configured to receive a high-pressure water stream from the central fluid line and a supply of the active agent from the storage tank 102. As the pressurized water stream (e.g., boosted city water at approximately 150 PSI) is forced through the narrowed orifice, the fluid is accelerated, causing a corresponding drop in static pressure in accordance with Bernoulli’s principle. This acceleration creates a “full vacuum” or localized suction zone within the injector body that is fluidly connected to the chemical delivery lines. In one or more embodiments, the venturi injector is configured to pull or “suck” the concentrated active agent directly into the water stream at the point of the localized vacuum. This interaction occurs within the dilution block, where the high-velocity water stream entrains the active agent to create the mixture. By utilizing a vacuum-driven draw, the venturi injector ensures that the active agent is introduced into the fluid stream at a consistent, proportional rate, facilitating a thorough and immediate dilution that is substantially independent of fluctuations in soap viscosity before the mixture is distributed to the wash applicators.

With continued reference to FIG. 1, dispensing system 100 further includes a valve 112. Valve may include any valve as described in this disclosure. In one or more embodiments, valve 112 may include a motorized ball valve. In one or more embodiments, valve may be used to control a flow of fluid from water solenoid and through designated channel 108. In one or more embodiments, pressure sensor 110 may be located between valve 112 and water solenoid 106 to identify a pressure of a fluid within channel 108. In one or more embodiments, water solenoid may provide fluid from one end of designated channel 108, wherein valve 112 may control a flow of fluid through designated channel. In one or more embodiments, valve 112 may include a motorized ball valve to adjust flow rate. In one or more embodiments, each designated channel 108 and/or water solenoid may include a valve 112 configured to control the flow rate of a fluid such as water. In one or more embodiments, valve 112 may include a motorized ball valve. A motorized ball valve is an automated valves that use an electric motor to operate the ball inside the valve, allowing precise control of fluid flow in a piping system. In one or more embodiments, motorized ball valve, may include an on/Off motorized ball valve, modulating motorized ball valves, multi-port motorized ball valves, fail-safe motorized all valves and/or the like. In one or more embodiments, valve 112 may include any proportional control valve, i.e., a valve whose flow aperture increases and decreases over a defined range via a digital or analog modulation signal operated by computing devices, analog control signal sources, or other devices in a feedback loop. This valve could also be the sole means of activating water flow, eliminating the need for a solenoid valve as the on/off water supply valve for a given dilution channel. In one or more embodiments, valve 112 may be configured to adapt to varying flow rates. In one or more embodiments, a controller such as any controller as described in this disclosure may be configured to actuate and/or manipulate valve 112 in order to control a flow of fluid though a channel within dilution block. In one or more embodiments, controller may be configured to transmit command signals to valve 112 in order to increase or decrease the flow rate of fluid navigating through dilution block. In one or more embodiments, a controller, such as any controller as described in this disclosure may use sensors such as level sensors, pressure sensors, flow meters and/or the like to identify a flow rate of fluid and/or active agent and adjust the flow rate of fluid to ensure proper dilution ratios between active agent and fluid.

With continued reference to FIG. 1, in one or more embodiments, dispensing system may include one or more flow meters 114. In one or more embodiments, flow meters 114 may allow for identification of a flow rate of fluid within designated channel 108 after navigation through valve 112. In one or more embodiments, flow meter 114 may be used to identify an amount of fluid that is allowed to pass through ball valve. In one or more embodiments, flow meter 114 may be used to control valve 112, such that flow meter 114 may identify an amount of fluid flowing, and a controller as described in detail below, may be used to control a flow rate of valve 112. This will be described in further detail below. In one or more embodiments, flow meter 114 may include any flow meter as described in this disclosure and/or any sensor used to monitor flow of a fluid.

In one or more embodiments, dispensing system 100 may include and/or be fluidly connected to airbox. An “Airbox” as described in this disclosure is a component configured to provide air to dispensing system. In one or more embodiments, airbox may provide air to dispensing system 100 such that air is injected into a mixture created by dispensing system. In one or more embodiments, Overall air pressure per application may be regulated by dispensing system 100. The air pressure set on dispensing system 100 should match what the pressure gauge is reading on the Airbox. The gauge in Airbox is after the airbox’s regulator and will indicate the output pressure of the secondary regulator present in the air boxes for each unique soap application. The regulator should be fully open (turned fully counterclockwise), and the needle valve should be used to adjust outgoing air. Each applicator contains its own needle valve to adjust its individual outgoing air which will adjust foaminess at that applicator. Overall outgoing air pressure settings and needle valve settings should match the standard settings highlighted on the table below. Additional components of dispensing system 100, such as airbox, will be described in further detail below.

With continued reference to FIG. 1, dispensing system 100 may include an air supply manifold 116 with solenoid valves. The air supply manifold 116 is designed and/or configured to manage and distribute compressed air for soap application within dispensing system 100. In the direction of airflow, the system begins with a pressure regulator, which ensures that the air pressure is reduced and maintained at a consistent, pre-set level suitable for the downstream components. Immediately following the regulator is an output pressure gauge and sensor, which continuously monitor and display the regulated air pressure, providing real-time feedback for system diagnostics or automation control. Next, the air flows into a distribution manifold, which serves as a hub to evenly route the regulated air to multiple outputs. These outputs are each connected to solenoid valves, with one valve dedicated to each soap application line. The solenoid valves control the on/off flow of air to their respective applicators, enabling precise control over soap dispensing operations.

With continued reference to FIG. 1, dispensing system 100 may include one or more sensors, such as for example, pressure sensor, flow meter, level sensor, and/or the like. Sensor may include one or more sensors. As used in this disclosure, a “sensor” is a device that is configured to detect an input and/or a phenomenon and transmit information related to the detection. For example, and without limitation, a sensor may transduce a detected charging phenomenon and/or characteristic, such as, and without limitation, temperature, voltage, current, pressure, and the like, into a sensed signal such as a voltage with respect to a reference. Sensor may detect a plurality of data. A plurality of data detected by sensor may include, but is not limited to pressure, temperature, carbon saturation, oxygen saturation, and/or the like. In one or more embodiments, and without limitation, sensor may include a plurality of sensors. In one or more embodiments, and without limitation, sensor may include an optical or image sensor such as a camera, a CMOS detector, a CCD detector, a video camera, a photodiode, a photovoltaic cell, a photoconductive device, a thermal and/or infrared camera, one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, and the like. Sensor may be a contact or a non-contact sensor. Signals may include electrical, electromagnetic, visual, audio, radio waves, or another undisclosed signal type alone or in combination.

With continued reference to FIG. 1, sensor may include a plurality of independent sensors, where any number of the described sensors may be used to detect any number of physical or thermal qualities associated with carbon capture chamber 116a-n. Independent sensors may include separate sensors measuring physical or thermal quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of sensor to detect phenomenon may be maintained.

With continued reference to FIG. 1, sensor may include a pressure sensor. A “pressure,” for the purposes of this disclosure, and as would be appreciated by someone of ordinary skill in the art, is a measure of force required to stop a fluid from expanding and is usually stated in terms of force per unit area. In non-limiting exemplary embodiments, a pressure sensor may be configured to measure atmospheric pressure and/or a change of atmospheric pressure. In some embodiments, a pressure sensor may include an absolute pressure sensor, a gauge pressure sensor, a vacuum pressure sensor, a differential pressure sensor, a sealed pressure sensor, and/or other unknown pressure sensors or alone or in a combination thereof. The pressor sensor may include a barometer. In some embodiments, the pressure sensor may be used to indirectly measure fluid flow, speed, water level, and altitude. In some embodiments, a pressure sensor may be configured to transform pressure into an analogue electrical signal. In some embodiments, the pressure sensor may be configured to transform a pressure into a digital signal.

With continued reference to FIG. 1, sensor may include a moisture sensor. “Moisture,” as used in this disclosure, is the presence of water, which may include vaporized water in air, condensation on the surfaces of objects, or concentrations of liquid water. Moisture may include humidity. “Humidity,” as used in this disclosure, is the property of a gaseous medium (almost always air) to hold water in the form of vapor. In an embodiment, a moisture sensor may include a hygrometer. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity,” for the purposes of this disclosure, is expressed as a percentage, indicating a present stat of absolute humidity relative to a maximum humidity given the same temperature. “Specific humidity,” for the purposes of this disclosure, is the ratio of water vapor mass to total moist air parcel mass, where parcel is a given portion of a gaseous medium. Humidity sensor may be psychrometer. Humidity sensor may be a hygrometer. Humidity sensor may be configured to act as or include a humidistat. A “humidistat,” for the purposes of this disclosure, is a humidity-triggered switch, often used to control another electronic device. Humidity sensor may use capacitance to measure relative humidity and include in itself, or as an external component, include a device to convert relative humidity measurements to absolute humidity measurements.

With continued reference to FIG. 1, sensor may include a moisture sensor. In one or more embodiments, dispensing system 100 may include moisture sensor configured to measure moisture datum.

With continued reference to FIG. 1, sensor may include thermocouples, thermistors, thermometers, infrared sensors, resistance temperature detectors (RTDs), semiconductor based integrated circuits (ICs), a combination thereof, or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor, may be measured in Fahrenheit (ºF), Celsius (ºC), kelvin (K), Rankine (ºR), or another scale alone or in combination. The temperature measured by sensors may include electrical signals, which are transmitted to their appropriate destination wireless or through a wired connection.

With continued reference to FIG. 1, sensor may include a plurality of sensing devices, such as, but not limited to, temperature sensors, humidity sensors, accelerometers, electrochemical sensors, gyroscopes, magnetometers, inertial measurement unit (IMU), pressure sensor, proximity sensor, displacement sensor, force sensor, vibration sensor, air detectors, hydrogen gas detectors, and the like. Sensor may be configured to detect a plurality of data, as discussed further below in this disclosure. A plurality of data may be detected from sensor.

With continued reference to FIG. 1, sensor may include a sensor suite which may include a plurality of sensors that may detect similar or unique phenomena. For example, in a non-limiting embodiment, a sensor suite may include a plurality of voltmeters or a mixture of voltmeters and thermocouples. System 100 may include a plurality of sensors in the form of individual sensors or a sensor suite working in tandem or individually. A sensor suite may include a plurality of independent sensors, as described in this disclosure, where any number of the described sensors may be used to detect any number of physical or electrical quantities associated with a charging connection. Independent sensors may include separate sensors measuring physical or thermal quantities that may be powered by and/or in communication with circuits independently, where each may signal sensor output to a control circuit. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained.

With continued reference to FIG. 1, sensor is configured to transmit a sensor output signal representative of sensed information. As used in this disclosure, a “sensor signal” is a representation of a sensed information that sensor may generate. A sensor signal may include any signal form described in this disclosure, for example digital, analog, optical, electrical, fluidic, and the like. In some cases, a sensor, a circuit, and/or a controller may perform one or more signal processing steps on a signal. For instance, sensor, circuit, and/or controller may analyze, modify, and/or synthesize a signal in order to improve the signal, for instance by improving transmission, storage efficiency, or signal to noise ratio.

With continued reference to FIG. 1, exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which vary continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines, and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued, and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 1, in one or more embodiments, dispensing system may include a first skid and a second skid. In one or more embodiments, a first skid may be associated with a beginning of a wash sequence and configured to house the dispensing channels and hardware necessary for initial cleaning stages. This functional grouping allows for the localized management of active agents that typically require higher dwell times or chemical agitation at the start of the wash process. For example, the first skid may be configured for a beginning of a wash sequence, wherein the beginning of a wash sequence includes dispensing channels for pre-soaks (e.g., Presoak 1 and Presoak 2), bug preparation solutions, and initial wheel or tire cleaners (e.g., CTA 1 and CTA 2). By consolidating these wet stage chemicals onto a single modular unit, the system optimizes the routing of fluid lines to the corresponding applicators located at the entry point of the wash tunnel. In one or more embodiments, the second skid may be associated with an end of the wash sequence and configured to house the dispensing channels for finishing and protection stages. In one or more embodiments, the second skid may be configured for an end of a wash sequence,. Wherein the end of a wash sequence includes the delivery of active agents applied after the primary cleaning is complete, such as waxes, drying agents, clear coat sealants, and ceramic coatings (e.g., Shine, Seal, and Weather X). Additionally, the second skid may house specialized, localized circuits for high-viscosity finishing products, such as an on-demand tire shine dispensing system, which operates independently of the standard Venturi-based dilution block. In one or more embodiments, this bifurcated architecture may be designed to simplify the physical installation and maintenance of the dispensing station. By dividing the system into a first skid and a second skid, the overall footprint is made modular, allowing for easier transport through standard entryways and positioning within the equipment room. Although the skids handle different phases of the wash sequence, they may utilize identical internal hardware and controller boards, with the specific functional logic (e.g., “beginning” vs. “end” sequence) being automatically assigned by the controller upon system boot-up based on the skid's physical location and network identity. This modularity ensures that the dispensing station can be scaled or serviced by replacing an entire skid unit without decommissioning the remaining wash functions.

With continued reference to FIG. 1, in one or more embodiments, dispensing system 100 may include a controller. Controller serves as the centralized intelligence for the dispensing station maintaining electrical communication with the plurality of peristaltic pumps 104 and water solenoids 106 to synchronize the delivery of the mixture. Both a first skid and a second skid utilize an identical controller hardware board, which is configured to automatically determine its identity as either a first-skid or second-skid controller upon system boot-up. This hardware identity is established through a strapping pin in the wiring harness that is either pulled to a ground state or left open, allowing the controller to load the specific channel configurations and operational logic relevant to its position in the wash sequence. In one or more embodiments, the controller may be configured to independently actuate each pump and water solenoid with high precision to achieve a target dilution ratio for the mixture. The controller may manage this actuation through a digital network protocol, such as MQTT, which facilitates granular control over the timing and duration of individual dispensing channels. To integrate with external car wash infrastructure, the system may further include a hardware interface configured to digitize 24V AC signals from an external wash controller and broadcast them over the network as digital MQTT triggers. This configuration enables controller to actuate the dispensing station in response to real-time wash commands while maintaining a digitized, data-rich operational environment. Controller is described in further detail below.

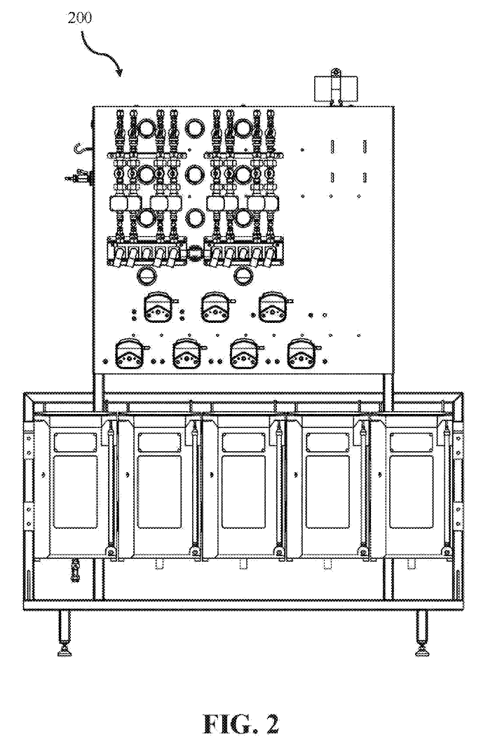

Referring now to FIG. 2, an exemplary embodiment of dispensing system 100 is described. In one or more embodiments, dispensing system 100 may lack an airbox in instances in which the injection of air may not be required and/or needed within mixture.

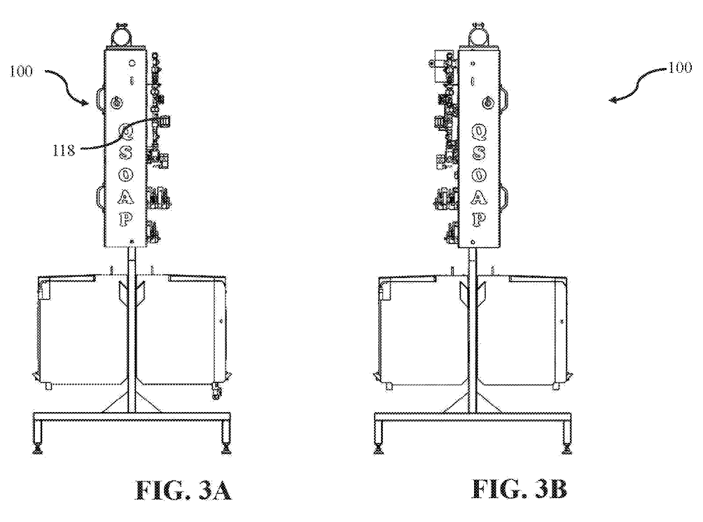

Referring now to FIGS. 3A-3B, an exemplary side view of dispensing system 100 is described. In one or more embodiments, dispensing system 100 may include modular skid frame wherein modular skid frame may include panel wherein components of dispensing system 100 may be housed within modular skid frame 118 and/or behind or within panel. In one or more embodiments, components of dispensing system 100 may include hosing, piping, wiring and/or any other components that provide a fluidic and/or electrical connection between two portions of dispensing system 100. In one or more embodiments, elements of dispensing system may be housed in one or more skids based on installation requirements.

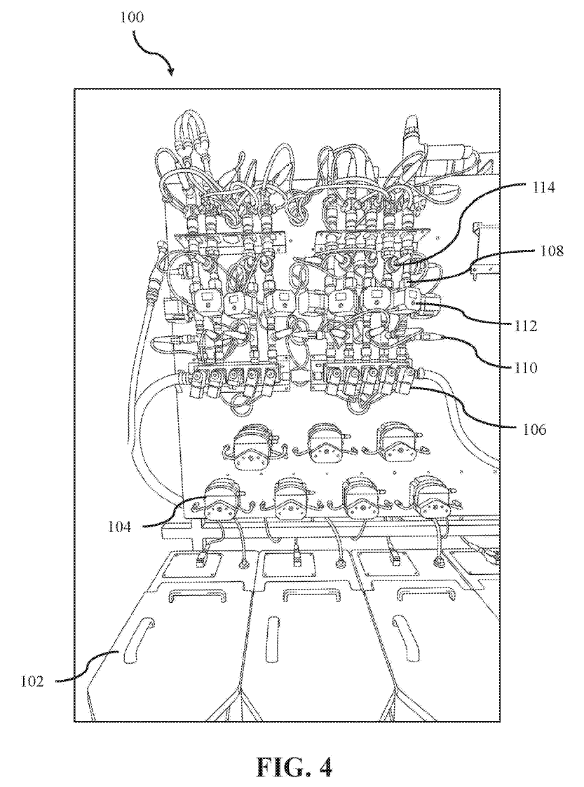

Referring now to FIG. 4, yet another exemplary embodiment of dispensing system 100 is described. In one or more embodiments, dispensing system 100 includes one or more storage tanks 102. In one or more embodiments, storage tanks 102 may be used to store active agents such as soap, soap mixture, and/or the like. In one or more embodiments, pumps such as peristaltic pumps 104 may be fluidly connected to storage tanks, wherein active agents within storage tanks may be extracted using peristaltic pumps 104. In one or more embodiments, dispensing system 100 may further include one or more water solenoids 106 configured to provide fluid, such as water to dispensing system 100. In one or more embodiments, dispensing system 100 may further include a pressure sensor 110 configured to identify a pressure of a fluid exiting water solenoid. In one or more embodiments, water solenoid may supply fluid to designated channel wherein pressure sensor 110 may identify a pressure of fluid prior to navigation through valve 112. In one or more embodiments, valve may be configured to control a flow rate of fluid through designated channel 108. In one or more embodiments, dispensing system 100 may contain valve 112 configured to control fluid navigating from water solenoid 106. In one or more embodiments, dispensing system 100 may further include a flow meter 114 configured to monitor a flow of fluid through valve. In one or more embodiments, flow meter may identify a flow fluid through a venturi valve as described in further detail below. In one or more embodiments, a controller as described in this disclosure may monitor a flow of fluid through flow meter 114, wherein controller may be configured to control a flow using automated valve 112.

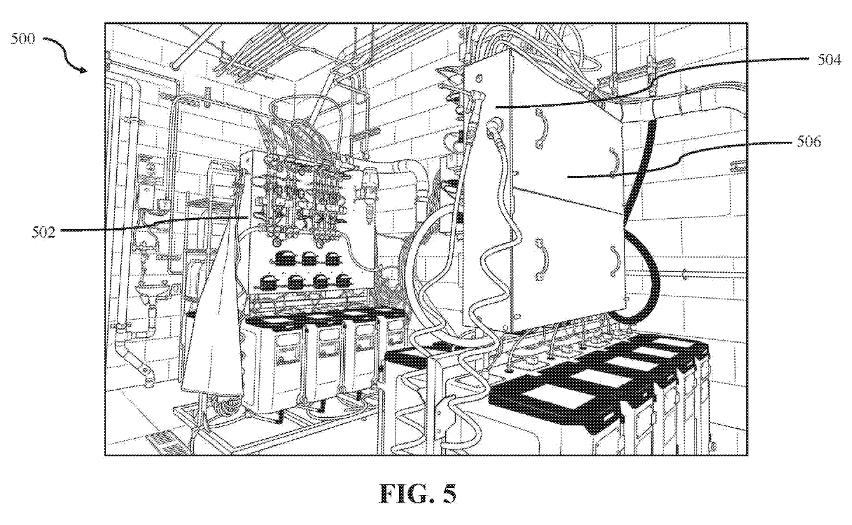

Referring now to FIG. 5, an exemplary embodiment of a dispensing station 500 is described. In one or more embodiments, dispensing station 500 may include more than one dispensing systems situated proximally to and/or parallel to one another. In one or more embodiments, dispensing station 500 may include multiple dispensing systems. In one or more embodiments, the use of multiple dispensing systems may allow for redundancy. In one or more embodiments, each dispensing system may be referred to as a ‘Skid,’ wherein a first dispensing station may be referred to as Skid 1 or a first skid 502 and a second dispensing station may be referred to as Skid 2 or a second skid 504. In one or more embodiments, dispensing station may include soap storage to hold additional soaps and/or active agents.

With continued reference to FIG. 5, in one or more embodiments, dispensing station 500 may be bifurcated into a first skid 502 (e.g., a left-hand skid) and a second skid 504 (e.g., a right-hand skid), wherein the functionality and dispensing channels are distributed between the two skids to facilitate modular installation and transport. The first and second skids may be configured as self-contained, mobile units having a footprint compatible with standard pallet jacks and forklifts. In one or more embodiments, each skid may be designed to require only a limited set of external utility connections to become operational, such as an Ethernet connection, a power connection (e.g., 277V), a water supply inlet, and a compressed air inlet. In one or more embodiments, the first skid and second skid may share a common hardware architecture while executing distinct functional roles based on their position within a wash sequence. For example, the first skid may house components related to initial wash phases (e.g., pre-soaks, wheel cleaners), while the second skid may house components related to finishing phases (e.g., waxes, drying agents, tire shine). Despite these functional differences, the first and second skids may utilize identical controller boards. In one or more embodiments, the controller board may be configured to automatically determine its identity as either a first-skid controller or a second-skid controller upon boot-up. This identification may be achieved through a hardware “strapping” mechanism, such as a specific pin in the wiring harness that is pulled to a ground state on one skid but left floating or pulled high on the other, allowing the firmware to load the appropriate configuration settings automatically.

With continued reference to FIG. 5, in one or more embodiments, each skid may include a frame and an enclosure 506 designed for rapid maintenance access. The enclosure 506 (also referred to as a rear manifold herein) may feature a flip-up rear access door supported by one or more gas struts, allowing an operator to access internal plumbing, pumps, and manifold blocks without removing the entire housing. In one or more embodiments, the frame of each skid may include an integrated horizontal support bar positioned above the pump assemblies. This support bar may include one or more pre-drilled apertures configured to receive an eye-bolt or similar lifting hardware, enabling the use of a hoist to lift and service heavy components, such as a water pump or motor, directly within the skid footprint. In one or more embodiments, the dual-skid architecture provides localized resource management. For example, a central air manifold may be localized to the first skid to distribute compressed air to both units, while a specialized high-viscosity circuit, such as a tire shine dispensing system, may be localized to the second skid. In one or more embodiments, the skids communicate over a local network (e.g., via the Ethernet connection) to synchronize dispensing timing and sensor data, ensuring that the bifurcated system operates as a single, cohesive dispensing station 500. This modularity allows for the independent replacement or upgrading of one skid without requiring the decommissioning of the entire dispensing station 500.

With continued reference to FIG. 5, in one or more embodiments, dispensing station 500 may include an enclosure 506 specifically configured to facilitate on-site maintenance and component replacement without requiring complete disassembly of the skid frame. The enclosure 506 may include a rear access panel moveably coupled to the frame. In a preferred embodiment, the rear access panel may be configured as a flip-up door supported by one or more gas struts (e.g., pneumatic springs). The gas struts may be configured to provide a controlled opening force and to maintain the rear access panel in an open, elevated position, thereby providing unobstructed, hands-free access to the internal components of the skid, including the manifold blocks, peristaltic pumps, and fluid routing.

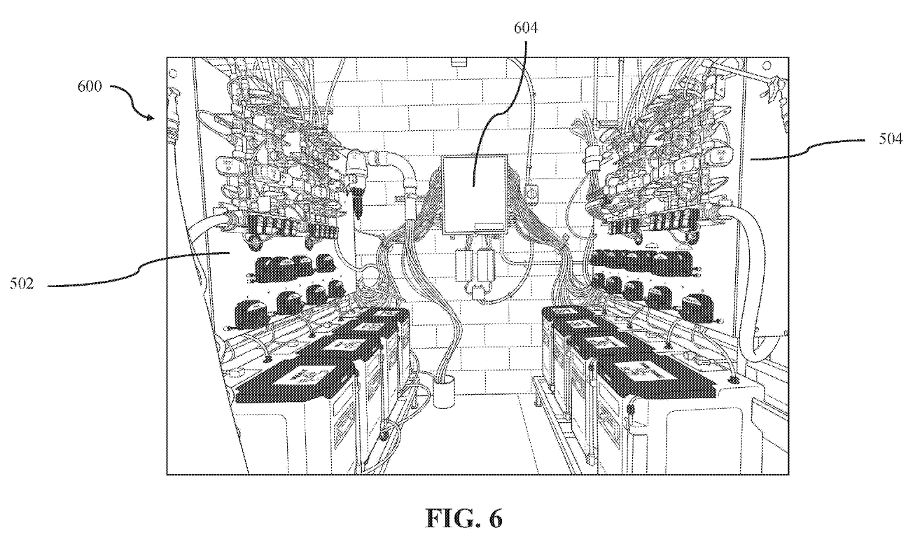

Referring now to FIG. 6, yet another exemplary embodiment of a dispensing station 600 is described. In one or more embodiments, dispensing station 600 may include a controller 604 communicatively connected to dispensing system 100. In one or more embodiments, controller 604 may include any controller as described in this disclosure. A “controller” for the purposes of this disclosure is a computing device configured to receive data and generate commands for dispensing system 100. For example, and without limitation, controller 604 may receive data from a sensor such as pressure sensor and/or flow meter and output a command for valve 112. In one or more embodiments, controller 604 includes a computing device. In one or more embodiments, controller 604 includes a processor. Processor may include, without limitation, any processor described in this disclosure. Processor may be included in a and/or consistent with computing device. In one or more embodiments, processor may include a multi-core processor. In one or more embodiments, multi-core processor may include multiple processor cores and/or individual processing units. “Processing unit” for the purposes of this disclosure is a device that is capable of executing instructions and performing calculations for a computing device. In one or more embodiments, processing units may retrieve instructions from a memory, decode the data, secure functions, and transmit the functions back to the memory. In one or more embodiments, processing units may include an arithmetic logic unit (ALU) wherein the ALU is responsible for carrying out arithmetic and logical operations. This may include, addition, subtraction, multiplication, comparing two data, contrasting two data and the like. In one or more embodiments, processing unit may include a control unit wherein the control unit manages execution of instructions such that they are performed in the correct order. In none or more embodiments, processing unit may include registers wherein the registers may be used for temporary storage of data such as inputs fed into the processor and/or outputs executed by the processor. In one or more embodiments, processing unit may include cache memory wherein memory may be retrieved from cache memory for retrieval of data. In one or more embodiments, processing unit may include a clock register wherein the clock register may be configured to synchronize the processor with other computing components. In one or more embodiments, processor may include more than one processing unit having at least one or more arithmetic and logic units (ALUs) with hardware components that may perform arithmetic and logic operations. Processing units may further include registers to hold operands and results, as well as potentially "reservation station" queues of registers, registers to store interim results in multi-cycle operations, and an instruction unit/control circuit (including e.g. a finite state machine and/or multiplexor) that reads op codes from program instruction register banks and/or receives those op codes and enables registers/arithmetic and logic operators to read/output values. In one or more embodiments, processing unit may include a floating-point unit (FPU) wherein the FPU may be configured to handle arithmetic operations with floating point numbers. In one or more embodiments, processor may include a plurality of processing units wherein each processing unit may be configured for a particular task and/or function. In one or more embodiments, each core within multi-core processor may function independently. In one or more embodiments, each core within multi-core processor may perform functions in parallel with other cores. In one or more embodiments, multi-core processor may allow for a dedicated core for each program and/or software running on a computing system. In one or more embodiments, multiple cores may be used for a singular function and/or multiple functions. In one or more embodiments, multi-core processor may allow for a computing system to perform differing functions in parallel. In one or more embodiments, processor may include a plurality of multi-core processors. Computing device may include any computing device as described in this disclosure, including without limitation a microcontroller, microprocessor, digital signal processor (DSP), and/or system on a chip (SoC) as described in this disclosure. Computing device may include, be included in, and/or communicate with a mobile device such as a mobile telephone or smartphone. Computing device may include a single computing device operating independently or may include two or more computing devices operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but are not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

With continued reference to FIG. 6, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 6, computing device may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 6, system 100 and/or controller 604 may include a memory communicatively connected to processor, wherein the memory contains instructions configuring processor to perform any processing steps as described herein. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device. Communicative connecting may also include indirect connections via, for example without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 6, memory may include a primary memory and a secondary memory. “Primary memory” also known as “random access memory” (RAM) for the purposes of this disclosure is a short-term storage device in which information is processed. In one or more embodiments, during use of computing device, instructions and/or information may be transmitted to primary memory wherein information may be processed. In one or more embodiments, information may only be populated within primary memory while a particular software is running. In one or more embodiments, information within primary memory is wiped and/or removed after computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor may access the information from primary memory.

With continued reference to FIG. 6, system 100 and/or controller 604 may include and/or be communicatively connected to a server, such as but not limited to, a remote server, a cloud server, a network server, and the like. In one or more embodiments. In one or more embodiments, computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by system computing device. In one or more embodiments, computing device may transmit processes to server wherein computing device may conserve power or energy.

With continued reference to FIG. 6, one or more processes as described in this disclosure may be performed by server. In one or more embodiments, processor may communicate with server to receive information needed for one or more instructions tasked by processor. In one or more embodiments, server may include one or more systems and/or software configured to provide information and/or data to processor. A “server” for the purposes of this disclosure is a system that provides resources, data, or services to other computing systems over a network. For example, without limitation, server may include a web server, a file server, a database server, and/or the like.

With continued reference to FIG. 6, one or more processes as described in this disclosure may be performed by server. In one or more embodiments, processor may communicate with server to receive information needed for one or more instructions tasked by processor. In one or more embodiments, server may include one or more systems and/or software configured to provide information and/or data to processor. A “server” for the purposes of this disclosure is a system that provides resources, data, or services to other computing systems over a network. For example, without limitation, server may include a web server, a file server, a database server, and/or the like.

With continued reference to FIG. 6, controller 604 may be configured to receive a datum, or multiple datums, from pressure sensor, flow meter, and/or any other device capable of sensing a phenomenon. In one or more embodiments, controller 604 may be configured to transmit commands to dispensing system 100 such as to valve 112 to control fluid rate. In one or more embodiments, dispensing system 100 may include a shut off switch. In one or more embodiments, shut off switch may allow for the immediate ceasing of electrical power to dispensing system 100.

Referring now to FIG. 7, yet another exemplary embodiment of dispensing system 700 is described. In one or more embodiments, dispensing system 700 may include peristaltic pumps 704 configured to extract active agent from storage tanks. In one or more embodiments, dispensing system 700 may include a PH sensor 712 configured to monitor fluid entering through water solenoid. In one or more embodiments, water entering through water solenoid may contain an unexpected and/or undesired PH, wherein PH sensor 712 may be configured to identify a PH of fluid entering through water solenoid. In one or more embodiments, dispensing system 700 may include a dilution block 716. In one or more embodiments, dilution block 716 may be consistent with designated channel. In one or more embodiments, dilution block 716 may include a portion of dispensing system in which fluid and active agent are combined to create mixture. In one or more embodiments, the PH sensor 712 may be located on the water main and designed to monitor TDS and PH of incoming city water. PH sensor 712 may be positioned on the outlet of a dilution block 716 that is easily accessible as the dilution block 716 applies water to rinse the bottom of the car without soap. In one or more embodiments, dilution block 716 may include pressure sensors, valves, flow meters, venturi valves, and/or the like. In one or more embodiments, dilution block 716 may include one or more pressure sensors, flow meters and/or valves as described in this disclosure to monitor back pressure and any potential issues. In an embodiment, sensors may be used to monitor backflow of active agent and/or fluid within dilution block 716. In one or more embodiments, a system, such as a system as described in reference to at least FIG. 17, may be configured to monitor sensors, collect a datum, and adjust flow valves, flow rates and, peristaltic pumps and/or the like accordingly. In one or more embodiments, dispensing system may include a tank level sensor 708. Tank level sensor 708 may include a sensor configured to measure an amount of active agent within each storage tank. In one or more embodiments, tank level sensor 708 may include any sensor as described in this disclosure and configured to identify an amount of active agent within storage tank. In one or more embodiments, tank level sensor may be consistent with ultrasonic sensor and/or ultrasonic level sensor as described in this disclosure.

Referring now to FIG. 8, an exemplary embodiment of a dilution block 800 is described. In one or more embodiments, dilution block may include and/or be consistent with designated channel as described above. In one or more embodiments, dilution block may include a pipe and/or a tubular structure configured to route fluid and mix active agent with fluid to provide mixture. In one or more embodiments, dilution block may include water solenoid configured to supply fluid to dilution block. In one or more embodiments, dilution block 800 may include a pressure sensor configured to identify a pressure of fluid from water solenoid. In one or more embodiments, dilution block may include a proportional/modulating valve configured to modulate and control a flow of fluid and/or water from water solenoid and through dilution block. In one or more embodiments, dilution block 800 may include a flow sensor configured to identify a flow of fluid out of valve. In one or more embodiments, dilution block 800 may include a soap tube. In one or more embodiments, peristaltic pump may navigate active agent through soap tube and into dilution block. In one or more embodiments, dilution block may be fluidly connected to soap tube wherein soap tube may supply active agent to dilution block. In one or more embodiments, soap tube and/or soap channel may include a soap inlet pressure sensor and configured to identify a pressure of soap tube. In one or more embodiments, soap inlet pressure sensor may be configured to identify pressure buildup within soap tube. In one or more embodiments, soap and/or active agent within soap tube may combine with fluid within dilution block to create mixture. In one or more embodiments, mixture may contain active agent and fluid. In one or more embodiments, an outlet of dilution block may include mixture. In one or more embodiments, dilution block may be configured to dilute active agent within a fluid such as water. In one or more embodiments, dilution block 800 may include an outlet pressure sensor. In one or more embodiments, outlet pressure sensor may be configured to identify a pressure of mixture at an outlet of dilution block.

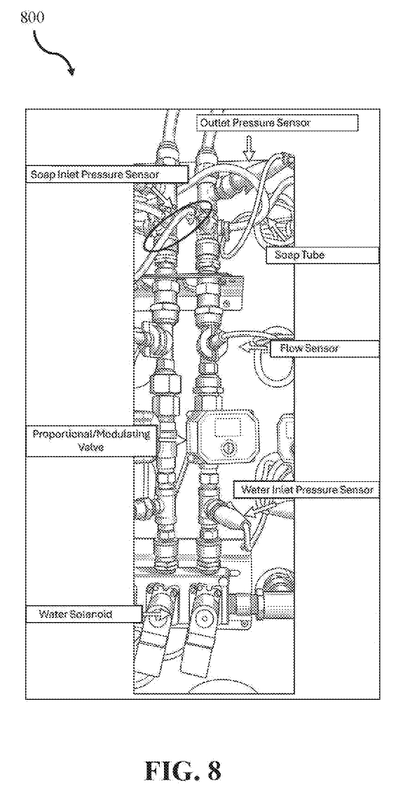

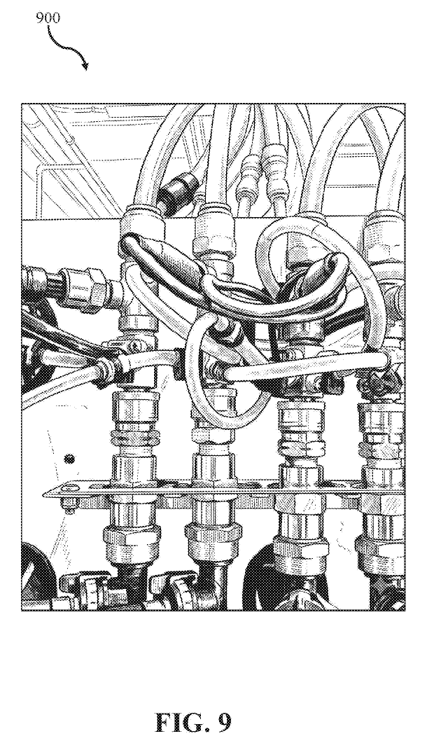

Referring now to FIG. 9, an exemplary embodiment of an injector system 900 is described. In one or more embodiments, injector system 900 includes a component configured to inject active agent into fluid within dilution block. In one or more embodiments, injector system may be consistent with dilution block as described in this disclosure. In one or more embodiments, injection system may include and/or be included within dilution block as described in this disclosure. In one or more embodiments, dilution block (as described in reference to FIG. 8 includes injector system 900. In one or more embodiments, injector system 900 may include as a venturi-based injector that uses the flow of water to draw and mix a concentrated chemical into a water stream at a specific dilution ratio. In one or more embodiments, injector system 900 is installed in a water line. As water flows through the injector, a venturi effect creates suction that pulls active agent and/or soap from a storge tank and/or from peristaltic pump. The active agent is mixed with water (e.g., fluid) and dispensed through a hose, sprayer, or other application tool. In one or more embodiments, injector system 900 may include a DEMA injector. In one or more embodiments, injector system 900 may be integrated within and/or a component of dilution block. In an injector system 900 such as a DEMA injector, the Venturi effect is created using a specifically shaped internal passage within the injector system 900. This passage includes a constricted throat section between two wider areas. As water enters the injector and passes through this narrowing, its velocity increases while the pressure drops significantly at the throat. This low-pressure zone is located adjacent to a soap inlet such as soap tube. Because the pressure at this port is lower than the pressure within the connected soap tube or reservoir, the pressure differential causes the active agent to be drawn into the water stream without the need for a mechanical pump. The injector’s internal check valve ensures that fluid only flows in the intended direction, preventing backflow. After the active agent is pulled in, the water and active agent l mix in the widening section beyond the throat, where velocity decreases and pressure begin to recover. This process enables continuous mixing of soap tube with water during flow. In one or more embodiments, injector system 900 may further ease pressure of peristaltic pump by extracting active agent that is present within soap tube. This reduces the stress on peristaltic pump to navigate active agent through soap tube, while the peristaltic pump (being a positive displacement pump) meters the flow rate of the active agent.

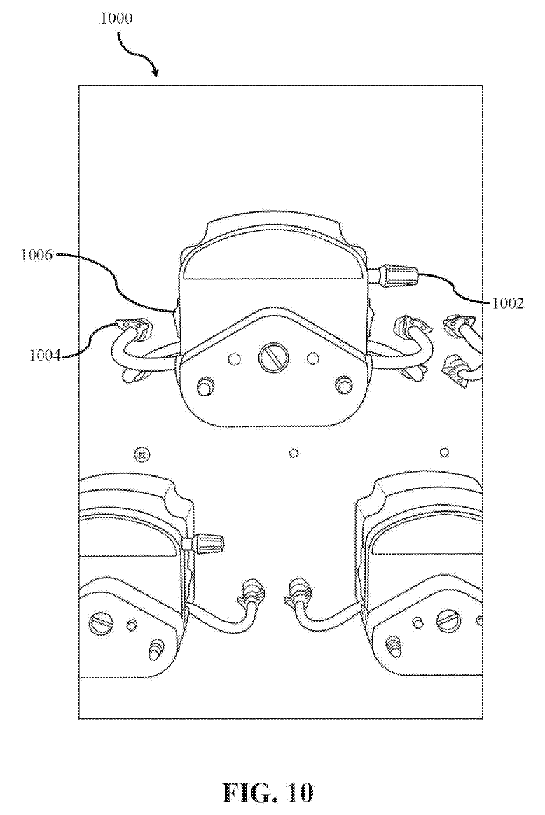

Referring now to FIG. 10, an exemplary embodiment of a peristaltic pump 1000 is described. In one or more embodiments, peristaltic pump may be configured to navigate active agent from storage tanks and through soap tube. In one or more embodiments, peristaltic pump may operate by compressing and releasing a flexible tube to move fluid (e.g., active agent) through it in a controlled manner. In one or more embodiments, peristaltic pump may include a pump head. The pump head may include the central housing where the tubing is placed and where the rollers or shoes compress the tubing to push fluid forward. In one or more embodiments, peristaltic pump may include a pump tube, such as soap tube. The pump tube may include an elastomeric tube that carries the active agent. The flexibility of pump tube allows it to be repeatedly compressed and released. In one or more embodiments, peristaltic pump may include a ribbed connector, typically made of plastic or metal, which secures the ends of the tubing to external supply or discharge lines. The ribs provide grip and prevent slippage when the tube is clamped. In one or more embodiments, peristaltic pump may include tube clamps 1004. The tube clamps 1004 may include a device that holds the tube securely onto the hose barbs or within the pump housing to prevent leaks and disconnections under pressure. In one or more embodiments, peristaltic pump may include a pump lever 1002. The pump lever 1002 may include a mechanical arm or handle used to open or close the pump head, often used to ease access when inserting or removing tubing. In one or more embodiments, peristaltic pump may include a tube retainer 1006. The tube retainer 1006 may include small brackets or clips inside the pump head that keep the tube properly aligned and held in place during operation, preventing the tube from shifting or kinking.

With continued reference to FIG. 10, in one or more embodiments, a controller, as described in this disclosure, may be configured to execute an adaptive calibration routine to maintain the high-precision delivery of the peristaltic pump. This routine may calculate a “pump trim” value by correlating the commanded rotations of the pump motor with the actual volumetric displacement of the active agent as measured by the tank level sensors (e.g., via the cylindrical tube). By comparing the predicted flow rate against the verified liquid depletion in the storage tank, the controller automatically adjusts the motor speed or duration to account for changes in chemical viscosity or atmospheric conditions, ensuring precise chemical ratios are maintained during the dispensing process. In one or more embodiments, the peristaltic pump may be configured in dual-motor or dual-head architecture to support high-volume applications or to provide system redundancy. In this configuration, two motors may be wired in parallel to operate as a single logical unit, or a single motor may drive multiple pump heads. This parallel arrangement allows for dispensing system to meet the increased volumetric demands of specific wash cycles by delivering active agent through multiple parallel circuits simultaneously. In one or more embodiments, these dual circuits may be synchronized through a single air channel to ensure uniform delivery and foam generation across multiple applicators.

With continued reference to FIG. 10, in one or more embodiments, peristaltic pump may be fluidly connected to a downstream Venturi-based dilution block. The pump may be configured to meter the concentrated active agent into the suction port of the Venturi, where it is combined with pressurized water (e.g., at approximately 150 PSI) provided by the water solenoid 106. This configuration utilizes the positive displacement characteristics of the peristaltic pump to provide a consistent mass flow of chemical that is independent of the pressure fluctuations within the main water line, while the Venturi provides the high-velocity mixing and vacuum necessary for efficient foam creation. In one or more embodiments, the peristaltic pump is controlled via a digital interface.

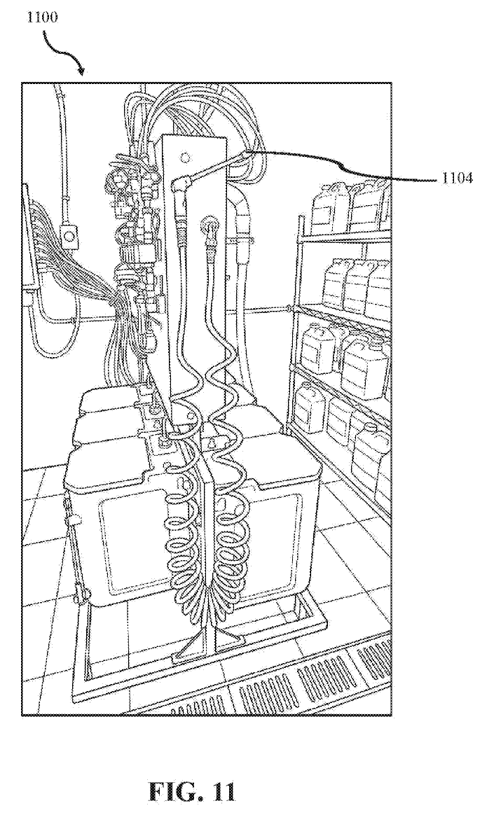

Referring now to FIG. 11, yet another exemplary embodiment of dispensing system 1100 is described. In one or more embodiments, dispensing system may include a water blaster 1104. In one or more embodiments, water blaster 1104 may include a pressurized hose configured to provide water at high pressure. In one or more embodiments, water blaster 1104 may be fluidly connected to dispensing system. In one or more embodiments, water blaster 1104 may provide water at high pressure to clean dispensing system 1100. In one or more embodiments, dispensing system 1100 may include a tank draining tube as well.

Referring now to FIGS. 12A-B, yet another exemplary embodiment of a dispensing system 1200a-b is described. In one or more embodiments, dispensing system 1200a-b includes a self-contained, modular skid assembly configured for rapid deployment and installation. The skid assembly may be constructed upon a structural frame 1202a-b designed to be pallet-jackable and forkliftable, facilitating ease of transport within a car wash facility. In one or more embodiments, the dispensing system 1200a-b may be configured to operate with a limited set of external utility connections, specifically a power connection (e.g., 277V), an Ethernet/PoE connection for data and E-stop signaling, a compressed air inlet, and a water supply inlet. In one or more embodiments, dispensing system 1200a-b includes a plurality of peristaltic pumps arranged in a vertical array to minimize the physical footprint of the station. Each peristaltic pump may be fluidly connected to a storage tank via a soap tube to move an active agent through the system. The active agents may be routed through transparent elastomeric tubing to allow for visual verification of fluid flow. In one or more embodiments, the peristaltic pumps may be configured in a dual-motor or dual-head architecture to support high-volume applications while maintaining synchronized delivery through a single air channel.

With continued reference to FIGS. 12A-B, in one or more embodiments, dispensing system 1200a-b may include one or more controllers. The controller may be configured to execute adaptive calibration routines, such as a pump trim algorithm, which utilizes data from an ultrasonic level sensor and a waveguide to verify the volumetric displacement of active agents. An interface may be configured to digitize 24V AC signals from external wash controllers and broadcast them via MQTT to trigger dispensing cycles. In one or more embodiments, the controller 200 includes a hardware identification pin that allows identical controller boards to automatically configure themselves as either a left or right skid component upon system boot-up.

With continued reference to FIGS. 12A-B, a lower portion of dispensing system 1200a-b may house a manifold and dilution complex. This complex includes a plurality of water solenoids fluidly connected to a central fluid line 1204. Upstream of the water solenoids 106, a water quality monitoring assembly, which may include pH, TDS, and conductivity sensors, analyzes the incoming fluid to allow the controller to adjust soap concentrations dynamically. Each designated channel includes an integrated dilution block housing a Venturi injector and a pressure sensor. In one or more embodiments, the central fluid line 1204 may include a pressure boosting assembly 1208 containing a plurality of redundant water booster pumps. The booster pumps may be configured to increase the incoming city water pressure to a target operating pressure of approximately 150 PSI. The plurality of booster pumps may be wired to communicate via a serial protocol, such as RS485, allowing them to operate in a “Cascade mode.” In this mode, the pumps negotiate their operation such that a secondary pump automatically activates to maintain system pressure if the primary pump fails or if the volumetric demand exceeds the capacity of a single pump.

With continued reference to FIGS. 12A-B, in one or more embodiments, dispensing system 1200a-b may be equipped with a comprehensive sensor network (e.g., "Q Sense") for fault detection and resolution. This network includes IFM sensors positioned in leak detection trays beneath the pump and manifold assemblies to identify aqueous or oil-based leaks. To facilitate maintenance, the skid frame includes a horizontal support bar positioned above the mechanical assemblies. The support bar features a pre-drilled aperture configured to receive an eye-bolt, enabling the use of a hoist for servicing high-mass components.

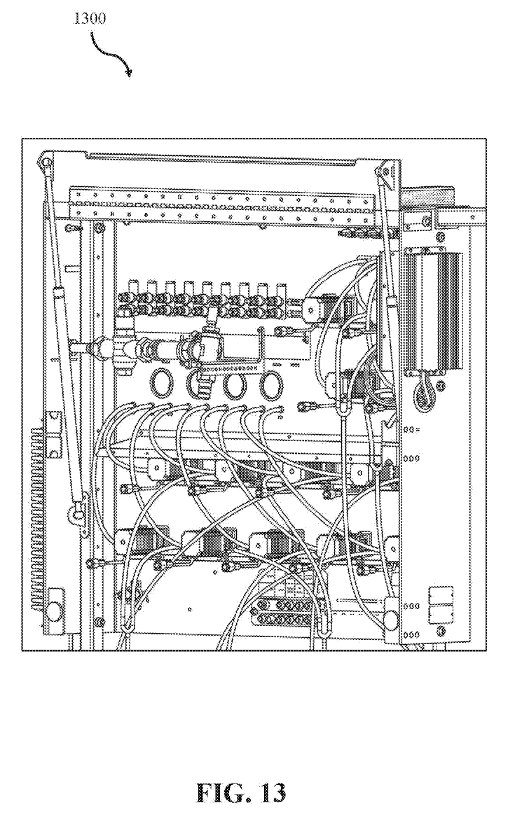

Referring now to FIG. 13, an exemplary embodiment of the air system management assembly 1300 situated on the rear of the dispensing station is described. In one or more embodiments, the air system management assembly 1300 may include one or more air boxes configured to regulate air pressure for specific wash applications, such as a “Duck Bath,” “Presoak,” or “Triple Foam”. Each air box may include a main system regulator and a pressure gauge, wherein the air pressure set at the dispensing station is configured to match the reading on the local air box pressure gauge. In one or more embodiments, each air box may further include a plurality of needle valves configured to provide independent adjustment for individual applicators, such as driver-side and passenger-side foamers, thereby allowing for granular control over the foam density at each specific point of use.

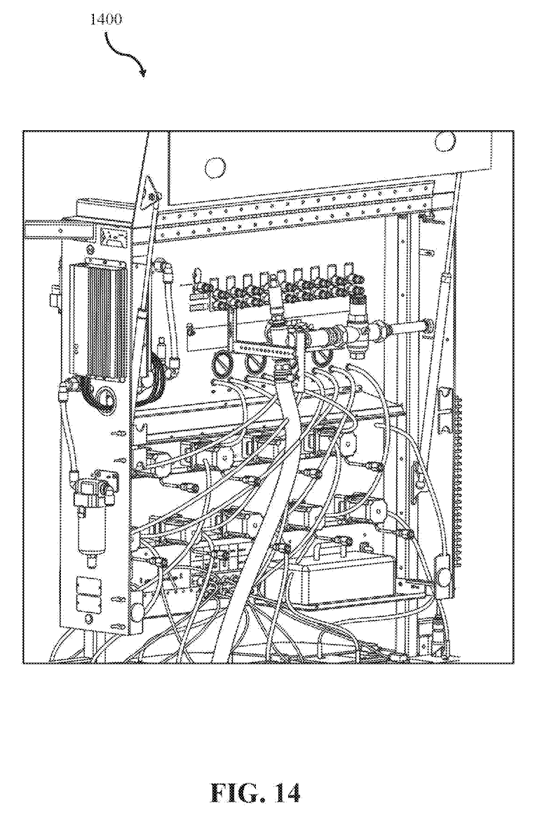

Referring now to FIG. 14, an exemplary embodiment of a specialized high-viscosity dispensing circuit 1400 situated on the rear of the dispensing station is described. In one or more embodiments, dispensing circuits may include a tire shine or “bug juice” system. In one or more embodiments, the high-viscosity dispensing circuit 1400 may be localized to the rear of the dispensing system, such as for example a first dispensing system and/or a second dispensing system, to isolate specialized chemical delivery from standard soap channels. In one or more embodiments, this circuit may be configured to operate in a semi-automatic, on-demand mode without the use of a peristaltic pump. In one or more embodiments, the system may utilize a pressure-based control logic where the dispensing valve automatically shuts off if the line pressure exceeds a high threshold (e.g., 100 PSI) and activates the fluid delivery when the pressure drops below a low threshold (e.g., 80 PSI) upon opening a manual applicator valve. In one or more embodiments, the high-viscosity dispensing circuit 1400 utilizes a Venturi-based suction mechanism powered by the boosted water supply (e.g., 150 PSI) to draw concentrated agent directly from the storage tanks. The circuit may be fluidly connected to a manual applicator, such as a spray wand or coiled hose assembly, allowing an operator to apply specialized agents to specific vehicle areas as part of a manual pre-treatment or finishing stage. In one or more embodiments, the operation of this circuit is monitored by an interface to log chemical consumption data independently of the automated wash sequences.

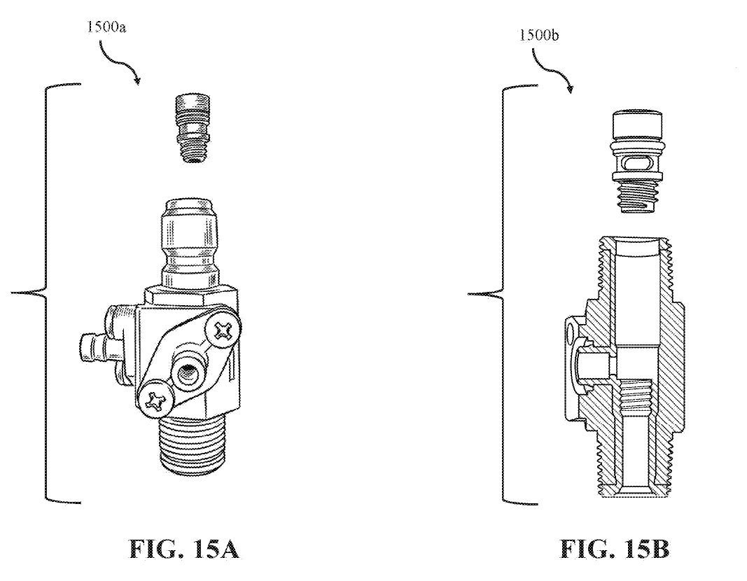

Referring now to FIG. 15A, an exemplary embodiment of an injector system 1500a is described. In one or more embodiments, injector system 1500a may include any injector system as described in this disclosure. In one or more embodiments, injector system 1500a may be used to combine a mixture of fluid and active agent such as soap and water. In one or more embodiments, injector system 1500a may create a negative pressure differential within soap tube, such that active agent within soap tube is pulled into dilution block. In one or more embodiments, injector system 1500a includes a venturi valve. A Venturi valve operates based on the principle of fluid dynamics in which a fluid's velocity increases as it passes through a constricted section of pipe, causing a drop in pressure. The valve contains a tapered internal chamber that begins with a wider inlet, narrows at the center, and then widens again at the outlet. This narrowing is known as the Venturi nozzle, and at its most restricted point lies the Venturi nozzle orifice, which is a sized opening that controls the rate at which pressure drops, and suction occurs. As fluid, typically water, flows through the valve and into the nozzle, its speed increases at the orifice, and static pressure decreases sharply at that point. This low-pressure zone is positioned near a side port or inlet, which allows another fluid, such as active agent to be drawn into the main flow (e.g., soap channel or dilution block) from the soap tube due to the pressure differential. The active agent enters the stream of fluid through a suction port on dilution block and is mixed with the moving water in the widening section beyond the orifice. The overall structure ensures that once initiated, this process continues as long as flow is maintained, with no moving parts required for the suction and mixing action. In one or more embodiments, use of a venturi nozzle may allow for a system to utilize the energy of flowing water to pump active agent through soap tube. In one or more embodiments, the negative pressure differential within soap tube may ensure that peristaltic pump does not need to increase work to ensure that active agent is pumped through soap tube. In one or more embodiments, injector system 1500a-b may reduce pressure placed on peristaltic pump and thereby increase the lifespan of peristaltic pump.

Referring now to FIG. 15B, an exemplary embodiment of a cross-sectional view of the injector system 1500b is described. The injector system 1500b includes a venturi nozzle orifice and a venturi nozzle.

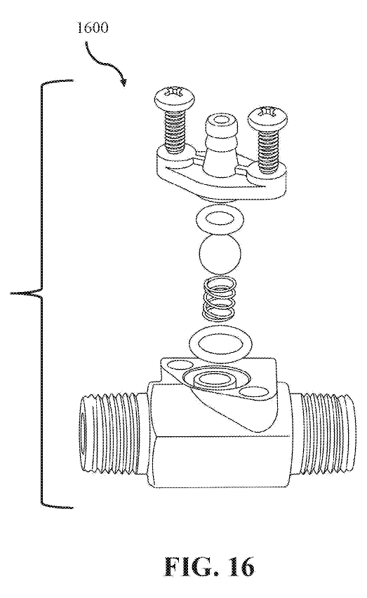

Referring now to FIG. 16, an exploded view of injector system 1600 is described. In one or more embodiments, injector system 1600 includes a barb, O-ring, spring, and ball work. The components of injector system 1600 create an internal check valve and active agent draw system. The barb is a ribbed connector that allows secure attachment of the soap tube. The barb ensures a tight seal and prevents the tubing from slipping off under suction. Just inside the injector body, the O-ring sits around the inlet and provides a watertight seal between the barb fitting and the injector housing, preventing leaks and maintaining proper suction pressure. Spring and ball form a one-way check valve mechanism. The ball rests against a seat inside the injector, held in place by the spring. When the water flow through the injector creates a vacuum at the soap inlet port, the differential pressure lifts the ball off its seat, compressing the spring and allowing chemical to be drawn in through the barb. When the system stops or backpressure is present, the spring pushes the ball back into place, sealing the port and preventing water or active agent from flowing backward into the storage tank.

Referring now to FIG. 17, an exemplary system 1700 for creating mixtures is described. In one or more embodiments, mixtures 1764 may include a combination of an active agent 1712 and a fluid 1704 such as water 1708. In one or more embodiments, active agent 1712 may include a cleaning product, such as soap, a mixture of chemicals used for cleaning vehicles and/or the like. In one or more embodiments, active agent 1712 may serve as the primary agent that is needed to clean a vehicle or another component. In one or more embodiments, mixtures 1764 may include a combination of fluid and active agent 1712 with precise amounts, such as for example, an 5% concentration of active agent 1712 within fluid and/or the like.

With continued reference to FIG. 17, system 1700 includes a dispensing system 1716. In one or more embodiments, dispensing system 1716 may include any dispensing system 1716 as described in this disclosure. In one or more embodiments, dispensing system 1716 includes a soap system 1720. A “soap system” as described in this disclosure refers to one or more components associated with the storage and movement of active agent. In one or more embodiments, soap system 1720 may include one or more storage tanks configured to store active agent 1712. In one or more embodiments, active agents may be poured and/or stored within storage tanks 1724 prior to use by system 1700. In one or more embodiments, storage tanks 1724 may include sensors 1728. In one or more embodiments, sensors 1728 may include any sensors described in this disclosure. In one or more embodiments, sensors 1728 utilized for storage tanks may include level sensors, ultrasonic sensors, and/or the like. In one or more embodiments, sensors 1728 may be used to identify a volumetric datum wherein a volumetric datum includes an amount of active agent within each storage tank. In one or more embodiments, soap system 1720 further includes a pump 1732. In one or more embodiments, pump 1732 may include any pump as described in this disclosure such as a peristaltic pump and/or a gear pump. In one or more embodiments, pump 1732 may be connected to storage tank by way of fluid connection such as through a hose and/or other piping that allows for fluid to flow from storage tank 1724 as a result of pump 1732. In one or more embodiments, pump 1732 may pump active agent 1712 from storage tank 1724 and through soap tube 1736. In one or more embodiments, soap tube 1736 may include any piping and/or hosing that allows for fluid to flow from storage tank 1724 without leakage. In one or more embodiments, soap tube 1736 may be made of a pliable material such as soft plastic, silicone, and/or the like. In one or more embodiments, a sensor 1728 may be located on the soap tube. In one or more embodiments, sensor 1728 on soap tube may include a pressure sensor configured to detect a pressure of active agent within soap tube 1736. In an embodiments, a buildup of pressure within soap tube 1736 may indicate that either pump 1732 is working too hard such that there is buildup, soap tube 1736 has been degraded and therefore flow rate has decreased and/or some other blockage down the line is causing a buildup of active agent 1712 within soap tube 1736 or that downstream backpressure on output has caused the venturi’s inlet pressure to reverse, eliminating the suction we expect during normal operation.

With continued reference to FIG. 17, dispensing system 1716 further includes a dilution block 1740. Dilution block 1740 includes any dilution block as described in this disclosure. In one or more embodiments, dilution block may be configured to route fluid 1704 through dilution block which may then be used to mix with active agent 1712. In one or more embodiments, an inlet of dilution block may include a water solenoid 1744. In one or more embodiments, water solenoid may include any solenoid 1744 as described in this disclosure. In one or more embodiments, fluid 1704 may be received from a city water line, a water tank connected to dispensing system 1716 and/or the like. In one or more embodiments, water solenoid may control a flow of fluid 1704 into dispensing system 1716. In one or more embodiments, water solenoid may be configured to provide a flow of fluid 1704 into dispensing system 1716. In one or more embodiments, a solenoid valve such as water solenoid 1744 may include an electromechanically operated valve. It may be controlled by an electric current (usually through a coil) which generates a magnetic field, causing the valve to open or close. In one or more embodiments, system 1700 may include a PH meter 1776. In one or more embodiments, PH meter 1776 may be configured to identify a PH of fluid 1704 prior to entry within dilution block. In one or more embodiments, information from PH meter may be transferred to a computing device, wherein the computing device (such as a controller as described in this disclosure) may be configured to identify a PH of the fluid and determine if the fluid is suitable for use. In an embodiment, a fluid containing a differing PH may interact negatively with active agent 1712.

With continued reference to FIG. 17, dilution block further includes a valve 1752. In one or more embodiments, valve 1752 may include any valve as described in this disclosure. In one or more embodiments, valve 1752 may be configured to control a flow or flow rate of fluid through dilution block 1740. In one or more embodiments, valve may be electromechanically operated, wherein valve 1752 may be operated through the use of commands transmitted by a controller 1772. In one or more embodiments, dilution block 1740 may contain a pressure sensor 1748 situated prior to valve and after water solenoid. In one or more embodiments, pressure sensor 1748 may monitor a pressure of fluid exiting water solenoid 1744 and entering valve 1752. In one or more embodiments, pressure sensor may be used to identify pressure drops from fluid entering through water solenoid. In one or more embodiments, fluid from valve 1752 may flow through dilution block 1740. In one or more embodiments, a flow meter 1756, such as any flow meter as described in this disclosure may be configured to monitor a flow rate or fluid after valve 1752. In one or more embodiments, a flow rate of fluid 1704 may decrease due to constrictions in flow rate placed by valve 1752. In one or more embodiments, flow meter 1756 may be used to ensure a proper flow rate through dilution block 1740.

With continued reference to FIG. 17, soap tube may be fluidly connected to dilution block 1740. In one or more embodiments, soap tube may be fluidly connected to dilution block such that active agent may flow from soap tube and into dilution block.

With continued reference to FIG. 17, dilution block 1740 further includes an injector system 1760. Injector system 1760 includes any injector system as described in this disclosure. In one or more embodiments, injector system 1760 may include a venturi valve configured to create a pressure differential that can be used to draw active agent from soap tube and into dilution block. A Venturi valve works by using the principles of fluid dynamics, specifically, the Venturi effect, to create a pressure differential that can be used to draw in active agent into a fluid stream of fluid 1704. Inside the Venturi valve is a specially shaped passage that narrows in the middle and then widens again, forming three sections: the inlet, the throat, and the outlet. As fluid 1704 enters the valve through the inlet, it flows into the throat, which is the narrowest part. Due to the constriction, the fluid velocity increases sharply in the throat, and as a result, the static pressure drops significantly in that area. Adjacent to this low-pressure zone is a suction port, where a secondary substance, such as active agent 1712, can be introduced. The drop in pressure at the throat creates a vacuum effect that pulls active agent into the main fluid flow within dilution block 1740. Once inside, the two fluids mix and continue through the expanding outlet section, where the flow slows down and pressure begins to recover. In one or more embodiments, fluid 1704 and active agent 1712 may combine to create mixture 1764 at an outlet of dilution block. In one or more embodiments, dispensing system 1716 may further include an air supply manifold 1768, wherein the air supply manifold is configured to supply air to the fluid and active agent combination in order to create mixture 1764 having air bubbles and/or foamy properties. In one or more embodiments, air supply manifold 1768 may allow for mixture to contain foamy properties and this allow for a better solution used to clean vehicles.

With continued reference to FIG. 17, system 1700 includes a controller 1772. Controller 1772 includes any controller as described in this disclosure. Controller 1772 may be configured to receive a datum from sensors 1728, pressure sensors, flow meters, and/or the like in order to ensure that system 1700 is working properly. In one or more embodiments, controller may be configured to increase pressure of pump 1732 as a result of a decrease in active agent entering mixture 1764. In one or more embodiments, controller 1772 may receive flow rate of fluid within dilution block 1740 from flow meter and transmit commands to valve 1752 in order to adjust valve to increase or decrease flow rate. In one or more embodiments, controller may utilize sensor 1728 within soap tube and sensor 1728 within storage tank to identify the rate at which active agent is entering dilution block. This may be done by identifying a change in volume of storage tank using sensor and/or identifying a flow rate of soap using sensors within soap tube 1736. In one or more embodiments, controller 1772 may use a flow rate of active agent 1712 and a flow rate of fluid as identified by flow meter 1756 to identify a concentration of active agent within mixture 1764. In one or more embodiments, changes in concentration may indicate fluid buildup and/or issues with system 1700. In one or more embodiments, dispensing system 1716 may include a plurality of dilution blocks 1740 and a plurality of soap systems 1720, wherein each soap system 1720 may contain a correlated dilution block 1740. In one or more embodiments, dispensing system 1716 may contain a plurality of soap systems 1720, wherein each soap system may be configured for a differing active agent, such as for example, an active agent used for windows of a vehicle, an active agent used for cleaning tires, an active agent used for cleaning various portions of the car and/or the like. In one or more embodiments, controller may be configured to monitor each soap system 1720 and each dilution block 1740 in order to modify and/or adjust flow rates accordingly. In one or more embodiments, system 1700 and/or dispensing system 1716 may contain redundant components all connected to the same outlet. For example, and without limitation, system 1700 may include more than one dispensing system 1716, wherein more than one dispensing system 1716 may be used to ensure that mixture may flow in the event of a failure within a first dispensing system 1716. In one or more embodiments, each dispensing system 1716 may be connected to the same or similar outlet, such that mixture may be created within either dispensing system 1716 and reach the same location.

With continued reference to FIG. 17, controller 1772 may be configured to adjust flow rates of fluid and/or active agent in order to ensure proper concentration within mixture 1764. In one or more embodiments, controller 1772 may identify concentration of mixture by receiving a flow rate from flow meter 1756 and calculating flow rate of active agent using sensor within soap tube and/or sensor within storage tanks. In one or more embodiments, controller 1772 may adjust flow rates my increasing a power input of peristaltic pump and thus increasing a flow rate of active agent. In one or more embodiments, controller may identify a flow rate of active agent and increase or decrease power to peristaltic pump in order to adjust flow rate due to degradation of one or more components. In one or more embodiments, controller may further be configured to adjust valve, such that a flow rate of fluid may increase or decrease in order to maintain a desired dilution ration between active agent and fluid within mixture.

With continued reference to FIG. 17. Controller 1772 may be configured to identify tube degradation within system 1700. “Tube degradation” as described in this disclosure refers to the capability of an object to continue transfer fluids. For example, and without limitation, soap tube may be configured to navigate active agent to dilution block. However, if soap tube has become degraded, soap tube may lack the ability to continue to transport active agent at the desired flow rate under the same conditions. In one or more embodiments, controller 1772 may be configured to identify a tube degradation, wherein the tube degradation indicates the capability of a tube to transport a fluid such as fluid 1704 and/or active agent. In one or more embodiments, tube degradation may be measured in maximum flow rate, a percentage in comparison to an ideal tube and/or the like. In one or more embodiments, tube degradation may be measured in terms of pressure needed by peristaltic pump to increase flow rate. In one or more embodiments, tube degradation may be measured in terms of increased power output of one or more components of system 1700 needed in order to maintain the same or similar flow rate. For example, tube degradation may be measured at 120%, wherein an increase of 20% of power output may be needed to maintain the desired flow rate. In one or more embodiments, a pump may be operated by a stepper motor wherein RPM of the pump is a known valve. In one or more embodiments, controller 1772 may identify tube degradation by comparing an actual flow rate to an expected flow rate. An “actual flow rate” as described in this disclosure refers to a flow rate that has been calculated based on the use of one or more sensors. An expected flow rate for the purposes of this disclosure refers to a flow rate that is expected under the current power output conditions of system 1700. For example, and without limitation, actual flow rate may be determined by identifying flow rate of active agent 1712 through sensors 1728, by identifying flow rate of fluid through flow meter 1756 and/or by identifying flow rate of mixture using a sensor located at or near mixture. In another nonlimiting example, expected flow rate may include a flow rate that is calculated based on system 1700 working ideally. For example, expected flow rate may include a flow rate of 1 gallon per minute in instances in which no tube degradation occurs. In an embodiment, expected flow rate may include an initial flow rate identified by system 1700 on a previous day, month year and/or the like. In one or more embodiments, expected flow rate may be stored in a database and retrieved by controller. In one or more embodiments, controller 1772 may be configured to calculate actual flow rate by identifying a change in volume within storage tank and/or identifying a pressure within dilution block. In one or more embodiments, controller 1772 may compare actual flow rate to expected flow rate and transmit commands to peristaltic pump, water solenoid, valve, and/or other electromechanical devices in order to increase power output and thus increase to decrease flow rate. In one or more embodiments, controller 1772 may identify tube degradation of system 1700 iteratively and adjust power output of various components accordingly.

With continued reference to FIG. 17, in one or more embodiments, a pump may be driven by a stepper motor, allowing precise control of rotational speed (RPM), which is a known and commanded parameter. Pump output may be directly proportional to RPM, assuming consistent mechanical and fluid conditions. Over time, the tubing connected to the pump may degrade due to chemical exposure or mechanical wear, leading to a reduction in the volume of fluid displaced per revolution. This degradation results in a lower actual flow rate for a given RPM. Actual Flow rate may then be determined by monitoring the change in tank level over time during dispensing. By measuring the volume dispensed, calculated from the rate of tank level change over a known time interval, the system can assess the real output of the pump. A calibration value, referred to as “pump trim,” may be periodically updated based on this observed flow rate. The pump trim value may be applied to the calculated nominal RPM to compensate for any discrepancy between expected and actual output. This adjustment ensures accurate dosing even as tubing characteristics change. The pump trim value may be maintained through ongoing calibration and is updated continuously throughout operation. When tubing is replaced, restoring original flow characteristics, the pump trim value is reset to a nominal baseline.

With continued reference to FIG. 17, in one or more embodiments, controller 1772 may be configured to store actual and expected flow rates on database. In one or more embodiments, controller 1772 may be configured to identify a change in tube degradation over time by plotting actual and expected flow rates over time. In one or more embodiments, controller may be configured to predict tube degradation and/or change in tube degradation over time by identifying trends in changes to expected and actual flow rates. Similarly, controller may be configured to identify component degradation wherein component degradation includes the ability of a component of system 1700 to work properly. In one or more embodiments, component degradation may include identification of a valve that does not work properly, identification of injection device not working properly and/or beginning to degrade. In one or more embodiments, controller 1772 may be configured to modify power output to one or more components of system in order to adjust for component degradation. In one or more embodiments, controller 1772 may be configured to predict degradation of components by identifying trends in actual vs expected flow rates. In one or more embodiments, controller 1772 may be configured to notify a user such as through a remote device, when a component has degraded and/or when a component is expected to require replacement due to degradation. In one or more embodiments, changes in environmental pressure, temperature and/or the like may affect flow rates. In one or more embodiments, controller 1772 may be configured to identify expected vs actual flow rates and adjust accordingly due to changes in the surrounding environment. For example, and without limitation, on a hotter day, actual flow rates may differ. In one or more embodiments, controller may use linear models and/or machine learning model to calculate and/or predict component degradation and/or tube degradation. In one or more embodiments, a surrounding environment of system 1700 may affect flow rates and/or dilution ratios. In one or more embodiments, factors affecting dilution ratios may include changes in humidity, changes in temperature, changes in PH of the fluid entering system, changes in chemicals within fluid entering system and/or the like. In one or more embodiments, controller may identify changes in flow rate that may emanate from environmental factors, wherein controller may adjust peristaltic pump and/or valve to ensure a desired dilution ratio between active agent and fluid. In one or more embodiments, controller may be configured to identify tube life estimation, wherein tube life estimation includes an indication on how long a tube can be used until it required replacement. In one or more embodiments, controller 1772 may use changes in tube degradation to calculate tube life estimation.

With continued reference to FIG. 17, soap system 1720 and/or storage tank 1724 may be configured to store active agents, such as active agents utilized for washing bugs off of vehicles. In one or more embodiments, active agent 1712 may include a bug remover pre-treatment for a vehicle. In one or more embodiments, the bug remover pre-treatment may include one or more chemicals designed to break down and loosen the proteins, sugars, and acids in bug splatter so they can be rinsed away more easily. In one or more embodiments, the pre-treatment may include alkaline surfactants, to break down organic matter such as bugs and tree sap. In one or more embodiments, the pre-treatment may include citrus-based solvents, used to cleaning as well. In one or more embodiments, the pre-treatment may further include enzymatic cleaners used to help digest organic matter. In one or more embodiments, soap system 1720 may be configured to store active agent 1712 such as pre-treatment to utilize active agent 1712 for cleaning a vehicle. In one or more embodiments, active agent 1712 may be diluted with fluid, such as water 1708 and navigated downstream to a car washing device. In one or more embodiments, the car washing device may include pumps, tubing and/or the like configured to expel the mixture 1764 at a high pressure.

With continued reference to FIG. 17, in one or mor embodiments, system 1700 may be activated and/or deactivated through the use of external devices. An “external device” for the purposes of this disclosure is a device separate from system 1700 that is configured to communicate with system 1700. For example, and without limitation, external device may include a remote device, such as a smart phone, wherein the smart phone may be configured to initiate system 1700 and allow for active agent 1712 to be pumped through system and thus mixture 1764 is created. In one or more embodiments, external device may include pressure sensors within a car wash tunnel, wherein engagement of the pressure sensors by a vehicle, may indicate to system 1700 to initiate pumps, water manifolds, and/or the like in order to create mixture 1764 and navigate mixture 1764 through system 1700 and into car wash tunnel onto vehicle. In one or more embodiments, external device may include ultrasonic sensors, pressure sensors and/or any other sensors configured to identify the presence of a vehicle. In one or more embodiments, external devices may be used to initiate system 1700 and communicate with controller to initiate generation of mixture 1764.

With continued reference to FIG. 17, in one or more embodiments, aspects of the present disclosure may allow for dilution adjustment. Dilution adjustment is achieved through digital control of water and chemical flow rates using a remote device communicatively connected to controller 1772. Controller may receive input from a user via a graphical user interface (GUI). The GUI may be presented on a remote device, such as a smart phone, laptop, and/or the like. In one or more embodiments, the GUI may present interactive sliders that correspond to dilution ratio settings. These inputs may be transmitted wirelessly or via a local network (e.g., Wi-Fi, Ethernet) to controller. The controller then adjusts either digital proportional valves or pump speeds, depending on the hardware configuration, to alter water and soap flow rates entering a venturi or mixing chamber. The adjustments may be performed in real time while the operator observes the output directly in the wash tunnel, enabling immediate response to desired changes in mixture characteristics. The GUI may be developed using common web-based frameworks and served from an embedded HTTP server within the control unit.

With continued reference to FIG. 17, system 1700 may include a tank level sensor, typically an ultrasonic, capacitive, or float-type sensor, installed in the soap reservoir within storage tank. This sensor may continuously report the fluid level to controller. Expected consumption rate is calculated based on known operational parameters such as pump RPM, commanded duty cycles, and dispensing intervals. Controller may compare the real-time rate of level depletion against the calculated expected rate over fixed time windows. If the observed depletion rate significantly exceeds the expected rate, system 1700 may flag a discrepancy indicating a possible major leak. This function may use a time-weighted moving average algorithm or threshold-based logic to avoid false positives from minor variations. Leak detection logic runs continuously and logs data to support diagnostics.

With continued reference to FIG. 17, coil current monitoring may be implemented by integrating current-sensing circuitry into the power lines supplying solenoid valves and stepper motor drivers. This may be typically done using Hall-effect current sensors, low-resistance current shunt monitors, or integrated motor driver feedback signals. The current draw may be sampled at a fixed frequency by an analog-to-digital converter and processed by controller 1772 to identify electrical characteristics such as normal energizing current, open coil (zero current when commanded on), or short circuit (excessive current). For stepper motors, this monitoring can also reveal mechanical stalling, cable faults, or partial winding failures. Current profiles may be stored and compared against known operational baselines, and any deviations outside pre-defined bounds can trigger diagnostics or alerts.

With continued reference to FIG. 17, a diagnostic system may operate on controller 1772 wherein the diagnostic system continuously collects data from sensors (e.g., pressure sensors, flow sensors), electrical inputs (e.g., valve states, motor currents), and logic conditions (e.g., command status vs. sensor feedback). It executes rule-based logic trees or conditional decision trees where individual fault criteria are evaluated in real time. For example, if outlet pressure sensors report values exceeding 20 psi while the water valve control signal is off and the valve coil current is measured at zero, the system infers a mechanical failure in the valve (stuck open). Each diagnostic rule has a unique identifier that corresponds to a fault code. These fault codes are logged, timestamped, and optionally displayed via a user interface or exported to maintenance systems. Diagnostic rules are defined using condition sets with logical operators and can be updated via firmware.

With continued reference to FIG. 17, Quick-disconnect fittings may be implemented using standardized push-to-connect or twist-lock connectors placed at critical junctions in a dilution channel, dilution block, and/or designated channel fluid pathway. These fittings allow for tool-less disconnection and reconnection of tubing, simplifying maintenance tasks such as tubing replacement, venturi cleaning, or chemical flushing. Material selection for these fittings must consider chemical compatibility (e.g., using EPDM, Viton, or polypropylene) and pressure rating consistent with the system’s operating parameters. Fittings may also be installed with locking clips or retention mechanisms to prevent accidental disconnection under pressurized conditions. Integration of flow shutoff valves directly into the fittings is also possible, allowing automatic sealing of lines when disconnected.

With continued reference to FIG. 17, in one or more embodiments, a positive displacement gear pump may replace the peristaltic pump, delivering chemicals and/or active agents at a regulated high pressure of approximately 75 psi. This pressure is sufficient to overcome backpressure and to inject the chemical directly into a pressurized water line without relying on venturi suction. The mixing point consists of a T junction where water and chemical converge. A check valve is installed on the chemical line at the T junction to prevent backflow into the gear pump when water pressure exceeds chemical line pressure. Flow regulation is controlled by the gear pump speed, set via a variable-frequency drive or electronically controlled motor. This configuration simplifies the fluid circuit and enables high-precision dosing by directly metering chemical volume per pump revolution, leveraging the consistent output characteristics of gear pumps.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

Referring now to FIG. 18, an exemplary embodiment of an airbox 1800 is described. In one or more embodiments, airbox 1800 may include a system configured to provide air to mixture within dispensing system. In one or more embodiments, airbox 1800 may be integrated and/or connected to dispensing system and configured to supply air to mixture. In one or more embodiments, airbox 1800 may be used in foaming systems. In one or more embodiments, airbox 1800 may include a compact, enclosed unit designed to regulate and distribute air into a soap and water mixture, enabling the creation of thick, clinging foam. In one or more embodiments, airbox 1800 may provide air to soap channel in order to distribute air into mixture. Proper air pressure regulation, along with correct needle valve settings, is essential for creating a consistent and effective soap and water foam mixture. The airbox 1800 may play a critical role in the regulation and distribution of compressed air to multiple foam applicators. Within the airbox 1800 enclosure, a secondary pressure regulator may be responsible for setting the final delivery pressure of the air that is sent to a foam system. The pressure gauge located in the airbox 1800 provides a direct indication of the output pressure from the secondary regulator, offering a clear view of the pressure level being fed to the downstream components, specifically, the needle valves. The output from the secondary regulator is routed to a series of needle valves, which serve as variable flow restrictors. These valves may not be intended to control pressure directly, but rather to fine-tune the airflow to each individual foam applicator. Since the foam applicators are plumbed in parallel, airflow balancing may ensure consistent chemical output across all applicators. The needle valves allow for this relative flow balancing, compensating for differences in line length, elevation, or minor variations in the applicators themselves. In one or more embodiments, a secondary pressure regulator is the primary and final means of controlling the system’s air pressure. The second pressure regulator may be the regulator that determines the maximum air pressure presented to the needle valves. The needle valves, in contrast, may not regulate pressure, but adjust flow within the pressure range established by the secondary regulator. In one or more embodiments, the gauges within airbox 1800 and the gauges within dispensing system may serve different parts of the system. The gauge on the dispensing system reflects conditions upstream (typically at or near the supply regulator), while the airbox gauge reflects the controlled, reduced pressure used specifically for foam application balancing. Air pressure is the driving force that introduces air into mixture, and if it is too low or too high, the foam texture can be compromised, resulting in either watery solution or overly dry, unstable foam. These individual needle valves allow for fine-tuning the foam output at each point of use, accounting for differences in line length or nozzle type. In one or more embodiments, airbox may include plugs. In one or more embodiments, plugs may include threaded inserts or caps used to seal unused ports or openings in the airbox manifold or housing. Plugs may ensure no air escapes from areas where connections aren’t required, maintaining pressure and integrity in the system. In one or more embodiments, airbox 1800 may include air manifolds. Air manifolds may distribute compressed air from a single source to multiple outlets. In one or more embodiments, a needly valve distribution manifold may distribute air to multiple applicators on a single arch. In one or more embodiments, airbox 1800 may be configured to provide air to multiple systems as described in this disclosure, such as for example, multiple dispensing systems, multiple soap channels and/or the like. In one or more embodiments, airbox 1800 may be configured to provide air to a single system and/or device containing multiple air outlets. In one or more embodiments, airbox 1800 may be used to supply air to dry a vehicle, supply air to create foam within a mixture and/or the like. In the airbox 1800, the manifold channels air to various points in the system, such as foam injectors or active agent mixing stations, allowing for even distribution and centralized control. In one or more embodiments, airbox 1800 may include plastic disconnects. Plastic disconnects, also known as quick-disconnect fittings or push-to-connect fittings, allow for fast and tool-free connection or disconnection of air lines. They may be made of durable plastic and can be used to simplify maintenance or changeouts in the air delivery system. In one or more embodiments, airbox 1800 may include pressure regulators. Pressure regulators may be installed to control the air pressure entering the system. Pressure regulators may allow for fine-tuning the air input, ensuring the correct pressure is applied to mix with the soap and water without over-pressurizing or under-delivering air to the foam generator. In one or more embodiments, airbox 1800 may include pressure gauges. Pressure gauges may provide a visual indication of the air pressure within the airbox or output lines. Gauges may help with troubleshooting, adjustment, and ensuring the system operates within optimal pressure ranges for foaming. In one or more embodiments, airbox 1800 may include needle valves. Needle valves may include precision valves used to finely adjust the flow rate of air entering the foam generation section. By turning the needle valve, operators can control how much air is introduced into the mixture, which directly influences foam texture and volume. In one or more embodiments, airbox 1800 may include plastic or poly tubing. Polyethylene or polyurethane tubing may bused to carry air from the airbox to various parts of the foaming system. It is lightweight, flexible, and chemically resistant, making it suitable for use in environments where chemical exposure and repeated flexing are common.

FIGS. 19A-19B are exemplary embodiments of the airbox 1800. In one or more embodiments, airbox 1800 may include needle valves, a flow manifold, a pressure gauge to identify pressure, a flow regulator to regulator flow of air and/or the like. In one or more embodiments, airbox may include a housing within components of airbox may be stored in housing. In one or more embodiments, housing may include a door and/or an opening allowing an individual to access components of airbox 1800.

Referring now to FIG. 20, a method 2000 for dispensing a soap mixture in a vehicle wash system is described. At step 2005, method 2000 includes providing a pressurized fluid to a central water line. At step 2010, method 2000 includes actuating a water solenoid to allow a stream of the pressurized fluid into a dilution block. At step 2015, method 2000 includes accelerating the stream of the pressurized fluid through a venturi injector within the dilution block to create a localized vacuum. At step 2020, method 2000 includes actuating a pump to move a supply of an active agent from a storage tank toward the dilution block. At step 2025, method 2000 includes drawing the supply of the active agent through an internal check valve of the dilution block and into the stream of the pressurized fluid via a suction force generated by the localized vacuum. At step 2030, method 2000 includes combining the supply of the active agent and the stream of the pressurized fluid within the dilution block to create a mixture for delivery to a wash applicator. This may be implemented with reference to FIGS. 1-19 and without limitation.

FIG. 21 shows a diagrammatic representation of one embodiment of a computing device in the exemplary form of a computer system 2100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 2100 includes a processor 2104 and a memory 2108 that communicates with each other, and with other components, via bus 2112. Bus 2112 may include any of several types of bus structures including, but not limited to, a memory bus, a memory controller, a peripheral bus, a local bus, and any combinations thereof, using any of a variety of bus architectures.

Processor 2104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 2104 may be organized according to Von Neumann and/or Harvard architecture as a non-limiting example. Processor 2104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 2108 may include various components (e.g., machine-readable media) including, but not limited to, a random-access memory component, a read only component, and any combinations thereof. In one example, a basic input/output system 2116 (BIOS), including basic routines that help to transfer information between elements within computer system 2100, such as during start-up, may be stored in memory 2108. Memory 2108 may also include (e.g., stored on one or more machine-readable media) instructions (e.g., software) 2120 embodying any one or more of the aspects and/or methodologies of the present disclosure. In another example, memory 2108 may further include any number of program modules including, but not limited to, an operating system, one or more application programs, other program modules, program data, and any combinations thereof. Memory 2108 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of software has been terminated. In one or more embodiments, primary memory may be referred to as “Volatile memory” wherein the volatile memory only holds information while data is being used and/or processed. In one or more embodiments, volatile memory may lose information after a loss of power.

Computer system 2100 may also include a storage device 2124. Examples of a storage device (e.g., storage device 2124) include, but are not limited to, a hard disk drive, a magnetic disk drive, an optical disc drive in combination with an optical medium, a solid-state memory device, and any combinations thereof. Storage device 2124 may be connected to bus 2112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 2124 (or one or more components thereof) may be removably interfaced with computer system 2100 (e.g., via an external port connector (not shown)). Particularly, storage device 2124 and an associated machine-readable medium 2128 may provide nonvolatile and/or volatile storage of machine-readable instructions, data structures, program modules, and/or other data for computer system 2100. In some embodiments, storage device 2124 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 2120 may reside, completely or partially, within machine-readable medium 2128. In another example, software 2120 may reside, completely or partially, within processor 2104.

Computer system 2100 may also include an input device 2132. In one example, a user of computer system 2100 may enter commands and/or other information into computer system 2100 via input device 2132. Examples of an input device 2132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 2132 may be interfaced to bus 2112 via any of a variety of interfaces (not shown) including, but not limited to, a serial interface, a parallel interface, a game port, a USB interface, a FIREWIRE interface, a direct interface to bus 2112, and any combinations thereof. Input device 2132 may include a touch screen interface that may be a part of or separate from display 2136, discussed further below. Input device 2132 may be utilized as a user selection device for selecting one or more graphical representations in a graphical interface as described above.

A user may also input commands and/or other information to computer system 2100 via storage device 2124 (e.g., a removable disk drive, a flash drive, etc.) and/or network interface device 2140. A network interface device, such as network interface device 2140, may be utilized for connecting computer system 2100 to one or more of a variety of networks, such as network 2144, and one or more remote devices 2148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 2144, may employ a wired and/or a wireless mode of communication. In general, any network topology may be used. Information (e.g., data, software 2120, etc.) may be communicated to and/or from computer system 2100 via network interface device 2140.

Computer system 2100 may further include a video display adapter 2152 for communicating a displayable image to a display device, such as display 2136. Examples of a display device include, but are not limited to, a liquid crystal display (LCD), a cathode ray tube (CRT), a plasma display, a light emitting diode (LED) display, and any combinations thereof. Display adapter 2152 and display 2136 may be utilized in combination with processor 2104 to provide graphical representations of aspects of the present disclosure. In addition to a display device, computer system 2100 may include one or more other peripheral output devices including, but not limited to, an audio speaker, a printer, and any combinations thereof. Such peripheral output devices may be connected to bus 2112 via a peripheral interface 2156. Examples of a peripheral interface include, but are not limited to, a serial port, a USB connection, a FIREWIRE connection, a parallel connection, and any combinations thereof.

Further referring to FIG. 21, a computing device may include any computing device as described in this disclosure, including without limitation a microcontroller, microprocessor, digital signal processor (DSP), and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 21, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 21, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware, and/or memory. Examples of operating systems include without limitation Unix, Linux, Microsoft Windows, Android, Disc Operating System (DOS), and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 2100, processor 2104, and memory 2108 may be virtualized; that is, a virtual machine and/or container may interact directly with such computing system 2100, processor 2104, and/or memory 2108, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 2104 comprises a plurality of processors and/or processor cores, virtualization may, in some cases, simulate or emulate a single (virtual) processor whose functions are allocated to one or more of the plurality of processors and/or processor cores. In this case, while processor 2104 may be said to be virtualized, processor 2104, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A dispensing system for a vehicle wash, comprising:
a modular skid frame;
a storage tank supported by the modular skid frame and configured to hold an active agent;
a pump fluidly connected to the storage tank;
a fluid line configured to provide a pressurized fluid greater than an atmospheric pressure level to the dispensing system;
a solenoid valve fluidly connected to the fluid line; and
a dilution block fluidly connected to both the solenoid valve and the pump, the dilution block configured to receive the pressurized fluid from the solenoid valve and the active agent from the pump to create a mixture.

2. The dispensing system of claim 1, further comprising an ultrasonic sensor mounted to the storage tank and a cylindrical tube extending vertically into the storage tank, wherein the cylindrical tube is configured to provide an isolated liquid surface for the ultrasonic sensor to identify an amount of the active agent remaining in the storage tank.

3. The dispensing system of claim 1, further comprising a controller in electrical communication with the pump and the solenoid valve, the controller configured to independently actuate the pump and the solenoid valve to deliver a controlled dilution of the mixture to a wash applicator.

4. The dispensing system of claim 3, further comprising a water quality monitoring assembly fluidly connected to the fluid line upstream of the solenoid valve, the water quality monitoring assembly comprising at least one of a pH sensor and a Total Dissolved Solids (TDS) sensor.

5. The dispensing system of claim 4, wherein the controller is configured to dynamically adjust a speed of the pump and actuation timing of the solenoid valve based on real-time data from the water quality monitoring assembly to maintain a consistent chemical concentration in the mixture.

6. The dispensing system of claim 1, wherein the pump comprises a peristaltic pump.

7. The dispensing system of claim 1, wherein the dilution block further comprises a venturi injector configured to receive the pressurized fluid from the solenoid valve and the active agent from the pump to create the mixture.

8. The dispensing system of claim 7, wherein the venturi injector is configured to:
receive a water stream from the fluid line and a supply of the active agent from the storage tank;
accelerate the water stream through an orifice of the venturi injector to create a vacuum; and
pull the active agent into the water stream within the dilution block to create the mixture.

9. The dispensing system of claim 1, the dispensing system further comprising a water blaster fluidly connected to the dispensing system.

10. The dispensing system of claim 1, wherein the dispensing system is a self-contained unit and is transportable.

11. The dispensing system of claim 1, wherein the dispensing system comprises one of a first skid or a second skid and wherein:
the first skid is associated with a beginning of a wash sequence; and
the second skid is associated with an end of the wash sequence.

12. A dispensing system for a vehicle wash, comprising:
a modular skid frame;
a plurality of storage tanks supported by the modular skid frame, wherein each storage tank of the plurality of storage tanks is configured to hold an active agent;
a plurality of pumps fluidly connected to the plurality of storage tanks;
a fluid line configured to provide pressurized fluid greater than an atmospheric pressure level to the dispensing system;
a plurality of solenoid valves fluidly connected to the fluid line and configured to provide a separate fluid stream for each dilution block of a plurality of dilution blocks; and
the plurality of dilution blocks fluidly connected to the plurality of solenoid valves and the plurality of pumps, wherein each dilution block is configured to receive the pressurized fluid from at least one solenoid valve of the plurality of solenoid valves and the active agent from at least one pump of the plurality of pumps to create a mixture.

13. The dispensing system of claim 12, further comprising an ultrasonic sensor mounted each storage tank and a cylindrical tube extending vertically into each storage tank, wherein the cylindrical tube is configured to provide an isolated liquid surface for the ultrasonic sensor to identify an amount of the active agent remaining in each storage tank.

14. The dispensing system of claim 12, further comprising a controller in electrical communication with the plurality of pumps and the plurality of solenoid valves, the controller configured to independently actuate each peristaltic pump and each solenoid valve to deliver a controlled dilution of the mixture to a wash applicator.

15. The dispensing system of claim 14, further comprising a water quality monitoring assembly fluidly connected to the fluid line upstream of the plurality of solenoid valves, the water quality monitoring assembly comprising at least one of a pH sensor and a Total Dissolved Solids (TDS) sensor.

16. The dispensing system of claim 15, wherein the controller is configured to dynamically adjust a speed of each pump and an actuation timing of each solenoid valve based on real-time data from the water quality monitoring assembly to maintain a consistent chemical concentration in the mixture.

17. The dispensing system of claim 12, wherein at least one pump of the plurality of pumps comprises a peristaltic pump.

18. The dispensing system of claim 12, wherein each dilution block of the plurality of dilution blocks further comprises a venturi injector configured to receive the pressurized fluid from the at least one solenoid valve of the plurality of solenoid valves and the active agent from the at least one pump of the plurality of pumps to create the mixture.

19. The dispensing system of claim 18, wherein each venturi injector is configured to:
receive a water stream from the fluid line and a supply of the active agent from at least one storage tank;
accelerate the water stream through an orifice of the venturi injector to create a vacuum; and
pull the active agent into the water stream within each dilution block of the plurality of dilution blocks to create the mixture.

20. The dispensing system of claim 12, the dispensing system further comprising a water blaster fluidly connected to the dispensing system.

21. The dispensing system of claim 12, wherein the dispensing system is a self-contained unit and is transportable.

22. The dispensing system of claim 12, wherein the dispensing system comprising one of a first skid or a second skid, and wherein:
the first skid is associated with a beginning of a wash sequence; and
the second skid is associated with an end of the wash sequence.
